(19) United States
(12) Patent Application Publication
(10) Pub. No.: US 2020/0280820 A1
(43) Pub. Date: Sep. 3, 2020

(54) ENABLING EFFICIENT POSITIONING OF A TARGET DEVICE IN A WIRELESS COMMUNICATION SYSTEM

(71) Applicant: Telefonaktiebolaget LM Ericsson (publ), Stockholm (SE)

(72) Inventors: Xin Zhang, Unterhaching (DE); Fredrik Gunnarsson, Linköping (SE); Henrik Rydén, Solna (SE); Sara Modarres Razavi, Linköping (SE)

(21) Appl. No.: 16/646,896

(22) PCT Filed: Sep. 13, 2017
(86) PCT No.: PCT/SE2017/050899

§ 371 Date: Mar. 12, 2020

(51) Int. Cl. H04W 4/029; H04W 24/08; G01S 1/14

(52) U.S. Cl. CPC H04W 4/029; G01S 1/14; H04W 24/08

(57) ABSTRACT

According to one of the aspects of the proposed technology, there is provided a method for positioning of a target device in a wireless communication system. The method comprises obtaining beam quality information relating to reference beams transmitted from at least two network nodes according to specific beam patterns, and obtaining beam pattern information representative of the specific beam patterns. The method also comprises determining a position of the target device based on the beam quality information and the beam pattern information. In this way, improved positioning accuracy may be obtained in an efficient manner.

### TECHNICAL FIELD

The proposed technology relates to a method for positioning of a target device in a wireless communication system, and supplementary methods for assisting in the positioning of a target device, a device configured to determine a position of a target device, and a target device comprising such a device, and a location server comprising such a device, as well as a device configured to assist in the positioning of a target device in a wireless communication system and a target device comprising such a device, and also a network node configured to assist in the positioning of a target device and a location server configured to assist in the positioning of a target device, as well as corresponding computer programs and computer-program products and an apparatus for positioning of a target device in a wireless communication system and apparatuses for assisting in the positioning of a target device.

### BACKGROUND

Positioning of target devices such as mobiles and/or other wireless devices in wireless communication systems is becoming increasingly important, ranging from simply determining the location of a device to advanced location-based services.

For example, positioning has been a topic in Long Term Evolution (LTE) standardization since 3GPP Release 9. The primary objective is to fulfill regulatory requirements for emergency call positioning. In 3GPP Release 14, positioning has been extended to support Internet-of-Things (IoT) use cases, such as wearable devices, asset tracking and environment monitoring. These devices require low power consumption and the capability to communication in challenging locations in terms of coverage such as indoors or deep indoors. Other use-cases that require positioning support are further-enhanced Machine-Type Communication (feMTC) and Narrow-Band IoT (NB-IoT).

FIG. 1 is a schematic diagram illustrating a basic simplified example of network nodes that may be involved in the positioning of a target device 10, namely one or more network nodes 20-1, 20-2 and/or a location server 30.

By way of example, positioning in LTE is supported by the architecture schematically illustrated in FIG. 2, with direct interactions between a device such as a User Equipment (UE) and a location server (e.g. an E-SMLC) via the LTE Positioning Protocol (LPP). There are also interactions between the location server and the evolved NodeB (eNodeB) via the LPPa protocol. The interactions between the eNodeB and the device is supported via the Radio Resource Control (RRC) protocol, and the positioning is initiated via the Mobility Management Entity (MME). The same positioning architecture is considered also for 5G, where entities essentially have similar functionality but different names. The 5G base station will be denoted gNodeB, the mobility management will be handled by the core Access and Mobility Management Function (AMF), the location server is denoted Location Management Function (LMF). It is also possible that the LTE and 5G components are mixed, for example with a 5G gNodeB connected to a LTE core network, and a LTE eNodeB connected to a 5G core network.

With the architecture illustrated in FIG. 2, the following positioning techniques are considered in LTE:
Enhanced Cell ID. Essentially cell ID information to associate the device to the serving area of a serving cell, and then additional information to determine a finer granularity position.
Assisted GNSS. GNSS information retrieved by the device, supported by assistance information provided to the device from E-SMLC
OTDOA (Observed Time Difference of Arrival). The device estimates the time difference of reference signals from different base stations and sends to the E-SMLC for multi-lateration.
UTDOA (Uplink TDOA). The device is requested to transmit a specific waveform that is detected by multiple location measurement units (e.g. an eNB) at known positions. These measurements are forwarded to E-SMLC for multi-lateration

In the evolution and revolution of the communication era, positioning remains as a strong and important feature, as it spurs up many business opportunities due to its low latency characteristic. One prominent use-case in so-called New Radio (NR) is to apply positioning in autonomous driving or connected vehicles. In this scenario, the requirement for positioning accuracy goes down to 1-meter.

To achieve this positioning accuracy requirement, Advanced Antenna Systems (AAS), which is believed to be the cornerstone in the future NR system, will likely play an important part. This is an area where technology has advanced significantly in recent years and where a rapid technology development is foreseen in the years to come. Advanced antenna systems may take the following forms:
Receiver Diversity
Transmit Diversity
Multiple Input Multiple Output (MIMO)
Fixed Multi-beam
Adaptive beam-forming

In this type system, base stations will send out multiple beams and measurements on beams from these Transmission-Reception Points (TRPs) will be performed and reported from UE. Discussions are ongoing in 3GPP on how to report beam level Reference Signal Received Power (BRSRP).

With multiple antennas at each TRP, a graphical representation of an antenna's directional gain pattern which is called beam pattern illustrates the coverage of beams in all directions. More importantly, the beam pattern contains authentic information on the configuration of all antenna receivers in the BS.

FIG. 3 is a schematic diagram illustrating an example beam pattern for a TRP, where the different curves correspond to the antenna gain in certain directions for two beams. For example, a UE measures a BRSRP of beam 1 of −60 dBm, and beam 2 of −68 dBm. Based on the beam pattern, an angle estimator could search for points with an antenna gain difference of 8 dB between beam 1 and beam 2. In the example of FIG. 3, a solution is illustrated with an arrow, implying an angle between the UE and TRP of around 0 degrees.

By extending to more than 2 beams, a better angle estimation is achieved. A signal processing method called “MUltiple Signal Classification” (MUSIC) is able to derive the accurate Angle of Departure (AoD) for the incoming signal by exploiting multiple beam information.

Given angle estimates and ranging distance estimates (that can be based on Round Trip Time (RTT) from the TRP, a position can be determined. The Timing Advance (TA) may provide the distance between the target device and the serving TRP, and the angle shows the direction along the circular distance solution which localizes the target device.

Despite the fact that Global Positioning System (GPS) and/or other Global Navigation Satellite Systems (GNSS) can be exploited for outdoor positioning to reach sub-meter accuracy, in very dense urban terrain, when Line-of-Sight (LoS) with the satellite system is blocked by high-rising buildings, achieving high accuracy by GNSS or assisted GNSS techniques is in serious doubt. Hence, using a cellular network for positioning can be a good alternative. However, currently there are severe limitations to the accuracy available from cellular network positioning.

Thus, there is a general demand for improved positioning in wireless communication systems.

### SUMMARY

It is an object to enable efficient positioning of a target device in a wireless communication system.

It is an object to provide a method for positioning of a target device in a wireless communication system.

Another object is to provide methods for assisting in the positioning of a target device in a wireless communication system.

Yet another object is to provide a device configured to determine a position of a target device in a wireless communication system.

It is also an object to provide a target device comprising such a device.

It is another object to provide a location server comprising such a device.

Yet another object is to provide a device configured to assist in the positioning of a target device in a wireless communication system.

Still another object is to provide a target device comprising such a device.

It is an object to provide a network node configured to assist in the positioning of a target device in a wireless communication system.

It is also an object to provide a location server configured to assist in the positioning of a target device in a wireless communication system.

Another object is to provide corresponding computer programs and computer-program products.

Yet another object is to provide an apparatus for positioning of a target device in a wireless communication system.

Still another object is to provide apparatuses for assisting in the positioning of a target device in a wireless communication system.

These and other objects are met by embodiments of the proposed technology.

The inventors have realized that with the current positioning techniques, the serving node is limited to estimate the position and/or AoD from its own antenna beam pattern based on the measurement report from a wireless device such as UE. There is no spatial diversity in angular estimation because the serving node is not aware of the beam pattern in other network nodes such as the neighboring network node(s). Additionally, the serving node does not exploit information related to neighboring beams for angular estimation. Hence, possible improvement(s) can be implemented to enhance the positioning estimation accuracy by exploiting information on the beam level corresponding to multiple network nodes in an efficient manner, e.g. from neighboring network node(s) and neighboring beams.

According to a first aspect, there is provided a method for positioning of a target device in a wireless communication system. The method comprises:
obtaining beam quality information relating to reference beams transmitted from at least two network nodes according to specific beam patterns;
obtaining beam pattern information representative of the specific beam patterns; and
determining a position of the target device based on the beam quality information and the beam pattern information.

According to a second aspect, there is provided a method for assisting in the positioning of a target device in a wireless communication system. The method comprises:
the target device performing beam quality measurements on reference beams transmitted from at least two network nodes according to specific beam patterns; and
the target device reporting beam quality information comprising information representative of the beam quality measurements and information representative of said at least two network nodes to a location server in the wireless communication system to enable positioning of the target device based on the beam quality information and beam pattern information representative of the specific beam patterns.

According to a third aspect, there is provided a method for assisting in the positioning of a target device in a wireless communication system. The method comprises:
a network node receiving a request for beam pattern information;
the network node providing, in response to the request, beam pattern information representative of at least one specific beam pattern used for transmission of at least one reference beam that allows beam quality measurements by the target device; and
the network node reporting the beam pattern information to the target device or a location server in the wireless communication system for enabling positioning of the target device based on the beam pattern information and corresponding beam quality measurements.

According to a fourth aspect, there is provided a method for assisting in the positioning of a target device in a wireless communication system. The method comprises:
a location server receiving a positioning request from the target device; and
the location server requesting at least two network nodes to send, to the target device or to the location server, beam pattern information representative of specific beam patterns used for transmission, from said at least two network nodes, of corresponding reference beams that allow beam quality measurements by the target device.

According to a fifth aspect, there is provided a device configured to determine a position of a target device in a wireless communication system. The device is configured to obtain beam quality information relating to reference beams transmitted from at least two network nodes according to specific beam patterns. The device is also configured to obtain beam pattern information representative of the specific beam patterns, and the device is configured to determine a position of the target device based on the beam quality information and the beam pattern information.

According to a sixth aspect, there is provided a target device comprising the device according to the fifth aspect.

According to a seventh aspect, there is provided a location server comprising the device according to the fifth aspect.

According to an eighth aspect, there is provided a device configured to assist in the positioning of a target device in a wireless communication system. The device is configured to perform beam quality measurements on reference beams transmitted from at least two network nodes according to specific beam patterns. The device is also configured to report beam quality information comprising information representative of the beam quality measurements and information representative of said at least two network nodes to a location server in the wireless communication system to enable positioning of the target device based on the beam quality information and beam pattern information representative of the specific beam patterns.

According to a ninth aspect, there is provided a target device comprising the device according to the eighth aspect.

According to a tenth aspect, there is provided a network node configured to assist in the positioning of a target device in a wireless communication system. The network node is configured to receive a request for beam pattern information. The network node is also configured to provide, in response to the request, beam pattern information representative of at least one specific beam pattern used for transmission of at least one reference beam that allows beam quality measurements by the target device. The network node is further configured to report the beam pattern information to the target device or a location server in the wireless communication system for enabling positioning of the target device based on the beam pattern information and corresponding beam quality measurements.

According to an eleventh aspect, there is provided a location server configured to assist in the positioning of a target device in a wireless communication system. The location server is configured to receive a positioning request from the target device. The location server is also configured to request at least two network nodes to send, to the target device or to the location server, beam pattern information representative of specific beam patterns used for transmission, from the at least two network nodes, of corresponding reference beams that allow beam quality measurements by the target device.

According to a twelfth aspect, there is provided a computer program comprising instructions, which when executed by at least one processor, cause the at least one processor to:
obtain beam quality information relating to reference beams transmitted from at least two network nodes according to specific beam patterns;
obtain beam pattern information representative of the specific beam patterns; and
determine a position of a target device based on the beam quality information and the beam pattern information.

According to a thirteenth aspect, there is provided a computer program comprising instructions, which when executed by at least one processor, cause the at least one processor to:
control a target device to perform beam quality measurements on reference beams transmitted from at least two network nodes according to specific beam patterns; and
provide a report on beam quality information comprising information representative of the beam quality measurements and information representative of said at least two network nodes for transmission to a location server in the wireless communication system to enable positioning of the target device based on the beam quality information and beam pattern information representative of the specific beam patterns.

According to a fourteenth aspect, there is provided a computer program comprising instructions, which when executed by at least one processor, cause the at least one processor to:
receive a request for beam pattern information;
provide, in response to the request, beam pattern information representative of at least one specific beam pattern used for transmission of at least one reference beam that allows beam quality measurements by a target device; and
provide a report on the beam pattern information for transmission to the target device or a location server in the wireless communication system for enabling positioning of the target device based on the beam pattern information and corresponding beam quality measurements.

According to a fifteenth aspect, there is provided a computer program comprising instructions, which when executed by at least one processor, cause the at least one processor to:
receive a positioning request from a target device; and
request at least two network nodes to send, to the target device or to a location server, beam pattern information representative of specific beam patterns used for transmission, from said at least two network nodes, of corresponding reference beams that allow beam quality measurements by the target device.

According to a sixteenth aspect, there is provided a computer-program product comprising a computer-readable medium having stored thereon a computer program according to any of the above aspects.

According to a seventeenth aspect, there is provided an apparatus for positioning of a target device in a wireless communication system. The apparatus comprises:
an obtaining module for obtaining beam quality information relating to reference beams transmitted from at least two network nodes according to specific beam patterns;
an input module for receiving beam pattern information representative of the specific beam patterns; and
a determination module for determining a position of the target device based on the beam quality information and the beam pattern information.

According to an eighteenth aspect, there is provided an apparatus for assisting in the positioning of a target device in a wireless communication system. The apparatus comprises:
a control module for controlling the target device to perform beam quality measurements on reference beams transmitted from at least two network nodes according to specific beam patterns;
a generating module for generating a report on beam quality information, comprising information representative of the beam quality measurements and information representative of said at least two network nodes, for transmission to a location server in the wireless communication system to enable positioning of the target device based on the beam quality information and beam pattern information representative of the specific beam patterns.

According to a nineteenth aspect, there is provided an apparatus for assisting in the positioning of a target device in a wireless communication system. The apparatus comprises:
an input module for receiving a request for beam pattern information;
a providing module for providing, in response to the request, beam pattern information representative of at least one specific beam pattern used for transmission of at least one reference beam that allows beam quality measurements by the target device; and
a generating nodule for generating a report on the beam pattern information for transmission to the target device or a location server in the wireless communication system for enabling positioning of the target device based on the beam pattern.

According to a twentieth aspect, there is provided an apparatus for assisting in the positioning of a target device in a wireless communication system. The apparatus comprises:
an input module for receiving a positioning request from the target device; and
a requesting module for requesting at least two network nodes to send, to the target device or to a location server, beam pattern information representative of specific beam patterns used for transmission, from said at least two network nodes, of corresponding reference beams that allow beam quality measurements by the target device.

In this way, efficient positioning of a target device in a wireless communication system is made possible, e.g. with higher accuracy than ever before.

Other advantages will be appreciated when reading the detailed description.

### BRIEF DESCRIPTION OF THE DRAWINGS

The embodiments, together with further objects and advantages thereof, may best be understood by making reference to the following description taken together with the accompanying drawings, in which:

FIG. 1 is a schematic diagram illustrating a basic simplified example of network nodes that may be involved in the positioning of a target device.

FIG. 2 is a schematic diagram illustrating an example of an architecture for supporting positioning in LTE.

FIG. 3 is a schematic diagram illustrating an example beam pattern for a TRP, where the different curves correspond to the antenna gain in certain directions for two beams.

FIG. 4 is a schematic flow diagram illustrating an example of a method for positioning of a target device in a wireless communication system.

FIG. 5 is a schematic flow diagram illustrating an example of a method for positioning of a target device in a wireless communication system according to a specific embodiment.

FIG. 6 is a schematic flow diagram illustrating another example of a method for positioning of a target device in a wireless communication system according to a specific embodiment.

FIG. 7 is a schematic flow diagram illustrating yet another example of a method for positioning of a target device in a wireless communication system according to a specific embodiment.

FIG. 8 is a schematic flow diagram illustrating still another example of a method for positioning of a target device in a wireless communication system according to a specific embodiment.

FIG. 9 is a schematic flow diagram illustrating another example of a method for positioning of a target device in a wireless communication system according to a specific embodiment.

FIG. 10 is a schematic flow diagram illustrating an example of a method for assisting in the positioning of a target device in a wireless communication system.

FIG. 11 is a schematic diagram illustrating an example of the step of the target device reporting beam quality information according to an embodiment.

FIG. 12 is a schematic flow diagram illustrating an example of a method for assisting in the positioning of a target device in a wireless communication system.

FIG. 13 is a schematic flow diagram illustrating another example of a method for assisting in the positioning of a target device in a wireless communication system.

FIG. 14 is a schematic flow diagram illustrating an example of a method for assisting in the positioning of a target device in a wireless communication system.

FIG. 15 is a schematic flow diagram illustrating an example of actions and/or steps from the perspective of a target device according to a specific embodiment.

FIG. 16 is a schematic flow diagram illustrating an example of actions and/or steps from the perspective of a network node according to a specific embodiment.

FIG. 17 is a schematic flow diagram illustrating an example of actions and/or steps from the perspective of a network node according to another specific embodiment.

FIG. 18 is a schematic flow diagram illustrating an example of actions and/or steps from the perspective of a network node according to yet another specific embodiment.

FIG. 19 is a schematic flow diagram illustrating an example of actions and/or steps from the perspective of a location server according to a specific embodiment.

FIG. 20 is a schematic flow diagram illustrating an example of actions and/or steps from the perspective of a location server according to another specific embodiment.

FIG. 21 is a schematic flow diagram illustrating an example of actions and/or steps from the perspective of a location server according to yet another specific embodiment.

FIG. 22 is a schematic flow diagram illustrating an example of actions and/or steps from the perspective of a target device according to a specific embodiment.

FIG. 23 is a schematic flow diagram illustrating an example of actions and/or steps from the perspective of a target device according to another specific embodiment.

FIG. 24 is a schematic flow diagram illustrating an example of actions and/or steps from the perspective of a network node according to a specific embodiment.

FIG. 25 is a schematic flow diagram illustrating an example of actions and/or steps from the perspective of a network node according to another specific embodiment.

FIG. 26 is a schematic flow diagram illustrating an example of actions and/or steps from the perspective of a location server according to a specific embodiment.

FIG. 27 is a schematic flow diagram illustrating an example of actions and/or steps from the perspective of a location server according to another specific embodiment.

FIG. 28 is a schematic diagram illustrating an example of a beam pattern for a specific beam.

FIG. 29A and FIG. 29B illustrate positioning obtained by vertical and horizontal AoD, respectively.

FIG. 30 is a schematic diagram illustrating a non-limiting example of positioning procedure(s) and components that may be involved in the proposed technology.

FIG. 31 is a schematic signaling and/or action diagram illustrating an example of the proposed technology according to an embodiment.

FIG. 32 is a schematic signaling and/or action diagram illustrating an example of the proposed technology according to another embodiment.

FIG. 33 is a schematic signaling and/or action diagram illustrating an example of the proposed technology according to yet another embodiment.

FIG. 34 is a schematic signaling and/or action diagram illustrating an example of the proposed technology according to still another embodiment.

FIG. 35 is a schematic signaling and/or action diagram illustrating an example of the proposed technology according to yet another embodiment.

FIG. 36 is a schematic signaling and/or action diagram illustrating an example of the proposed technology according to another embodiment.

FIG. 37 is a schematic block diagram illustrating an example of a device configured to determine a position of a target device in a wireless communication system, based on a processor-memory implementation according to an embodiment.

FIG. 38A is a schematic block diagram illustrating an example of a target device 10 comprising the device 100 for positioning.

FIG. 38B is a schematic block diagram illustrating an example of a location server 30 comprising the device 100 for positioning.

FIG. 39 is a schematic block diagram illustrating an example of a device configured to assist in the positioning of a target device in a wireless communication system, based on a processor-memory implementation according to an embodiment.

FIG. 40 is a schematic block diagram illustrating an example of a target device comprising the device for assisting in the positioning of the target device.

FIG. 41 is a schematic block diagram illustrating an example of a network node configured to assist in the positioning of a target device in a wireless communication system, based on a processor-memory implementation according to an embodiment.

FIG. 42 is a schematic block diagram illustrating an example of a location server configured to assist in the positioning of a target device in a wireless communication system, based on a processor-memory implementation according to an embodiment.

FIG. 43 is a schematic diagram illustrating an example of a computer-implementation according to an embodiment.

FIG. 44 is a schematic diagram illustrating an example of an apparatus for positioning of a target device in a wireless communication system.

FIG. 45 is a schematic diagram illustrating an example of an apparatus for assisting in the positioning of a target device in a wireless communication system.

FIG. 46 is a schematic diagram illustrating an example of an apparatus for assisting in the positioning of a target device in a wireless communication system.

FIG. 47 is a schematic diagram illustrating an example of an apparatus for assisting in the positioning of a target device in a wireless communication system.

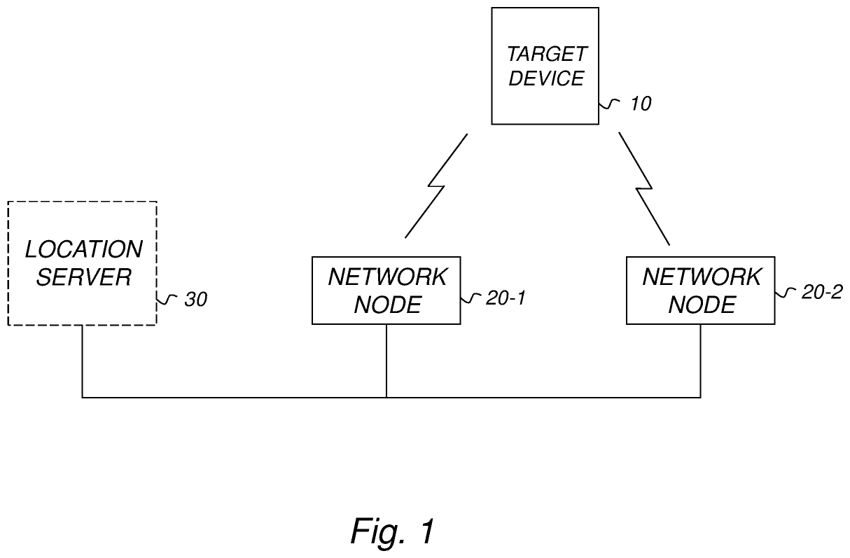

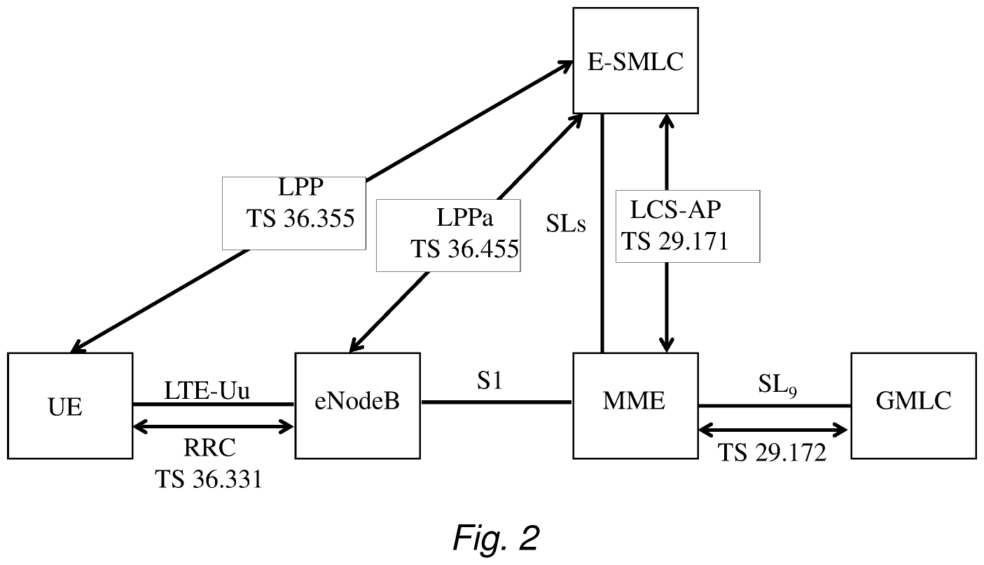

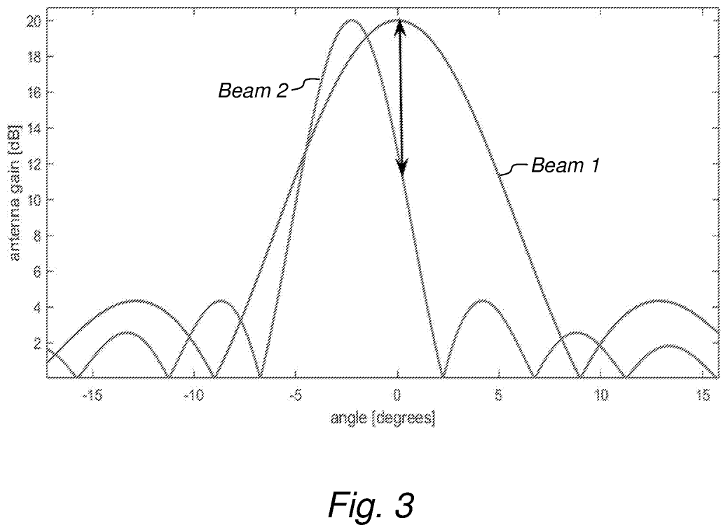

### DETAILED DESCRIPTION

Throughout the drawings, the same reference designations are used for similar or corresponding elements.

As used herein, the non-limiting term “target device” may refer to any wireless communication device such as User Equipment (UE), a mobile, a cellular phone, a station, a terminal, a Personal Digital Assistant (PDA), equipped with radio communication capabilities, a smart phone, a laptop or Personal Computer (PC), equipped with an internal or external mobile broadband modem, a tablet with radio communication capabilities, a target device, a device to device UE, a machine type UE or UE capable of machine to machine communication, Customer Premises Equipment (CPE), Laptop Embedded Equipment (LEE), Laptop Mounted Equipment (LME), USB dongle, a portable electronic radio communication device, a sensor device equipped with radio communication capabilities or the like. In particular, the term “wireless communication device” should be interpreted as non-limiting terms comprising any type of wireless device communicating with a network node in a wireless communication system and/or possibly communicating directly with another wireless communication device. In other words, a wireless communication device may be any device equipped with circuitry for wireless communication according to any relevant standard for communication.

As used herein, the non-limiting term “network node” may refer to base stations, access points, radio units, network control nodes such as network controllers, radio network controllers, base station controllers, access controllers, and the like. In particular, the term “base station” may encompass different types of radio base stations including standardized base station functions such as Node Bs, or evolved Node Bs (eNBs) and/or gNodeBs, and also macro/micro/pico radio base stations, home base stations, also known as femto base stations, relay nodes, repeaters, radio access points, Base Transceiver Stations (BTSs), and even radio control nodes controlling one or more Remote Radio Units (RRUs), or the like.

As used herein, the term “network device” may refer to any device located in connection with a communication network, including but not limited to devices in access networks, core networks and similar network structures. The term network device may also encompass computer-based network devices such as cloud-based network devices for implementation in cloud-based environments.

As used herein, the term “location server” may refer to any computer-implemented device, unit or node that is configured for positioning and/or location of a target device.

As mentioned, the inventors have realized that with the current positioning techniques, the serving node is limited to estimate the position and/or AoD from its own antenna beam pattern based on the measurement report from a wireless device such as UE. There is no spatial diversity in angular estimation because the serving node is not aware of the beam pattern in other network nodes such as the neighboring network node(s). Additionally, the serving node does not exploit information related to neighboring beams for angular estimation. Hence, possible improvement(s) can be implemented to enhance the positioning estimation accuracy by exploiting information on the beam level corresponding to multiple network nodes in an efficient manner, e.g. from neighboring network node(s) and neighboring beams.

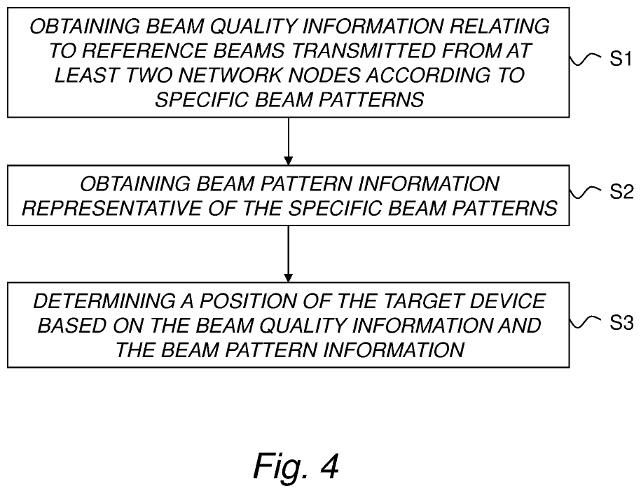

FIG. 4 is a schematic flow diagram illustrating an example of a method for positioning of a target device in a wireless communication system. The method comprises the following steps:

S1: obtaining beam quality information relating to reference beams transmitted from at least two network nodes according to specific beam patterns;

S2: obtaining beam pattern information representative of the specific beam patterns;

S3: determining a position of the target device based on the beam quality information and the beam pattern information.

For example, the beam quality information may include information representative of beam quality measurements on the reference beams by the target device.

By way of example, the beam quality information may include information representative of Beam Reference Signal Received Power, BRSRP, and/or Beam Reference Signal Received Quality, BRSRQ.

For example, the beam quality information may be associated with beam identification information allowing identification of the reference beams.

By way of example, the beam pattern information may include information representative of main lobe, beam width and/or beam angle.

In a particular example, the beam pattern information for each reference beam corresponds to the specific beam pattern used at the time of measurement of the reference beam.

As an example, the beam quality information may be associated with time stamp information representative of the time of measurement of each reference beam, and the beam pattern information for each reference beam corresponds to the specific beam pattern used at the time of measurement as indicated by the time stamp information.

The proposed technology is generally applicable for exploiting beam-related information corresponding to multiple networks nodes to improve the positioning accuracy. For example, the at least two network nodes referred to above comprises a serving network node of the target device and at least one neighboring network node.

In a first set of examples outlined below, the method may be performed by the target device.

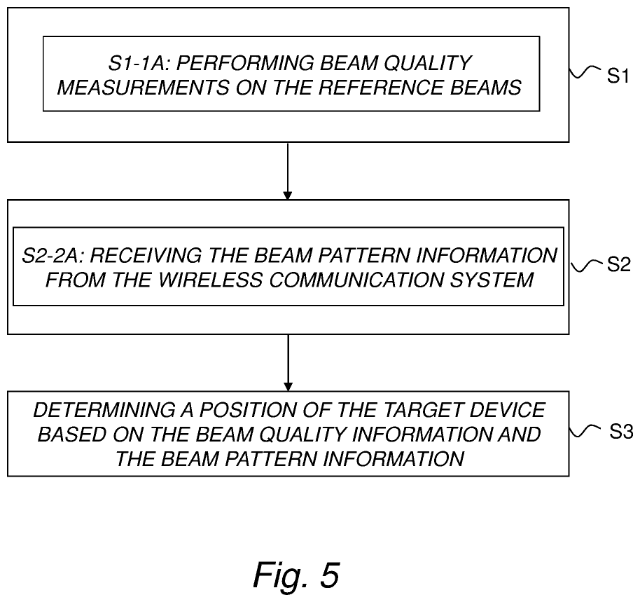

FIG. 5 is a schematic flow diagram illustrating an example of a method for positioning of a target device in a wireless communication system according to a specific embodiment.

In this particular example, the step S1 of obtaining beam quality information comprises performing S1-1A beam quality measurements on the reference beams, and the step S2 of obtaining beam pattern information comprises receiving S2-1A the beam pattern information from the wireless communication system.

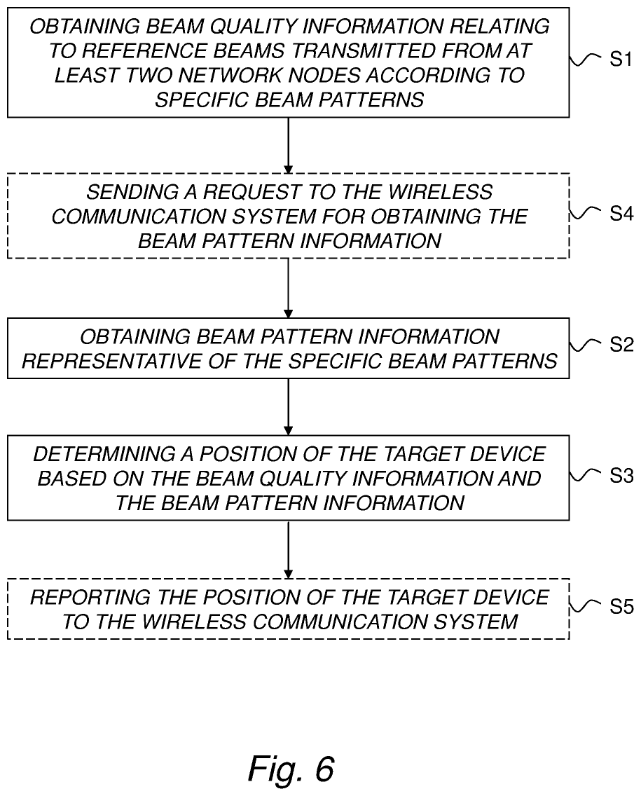

FIG. 6 is a schematic flow diagram illustrating another example of a method for positioning of a target device in a wireless communication system according to a specific embodiment.

In this particular example, the method may further comprise sending S4 a request to the wireless communication system for obtaining the beam pattern information.

Optionally, the method further comprises reporting S5 the position of the target device to the wireless communication system.

In another set of examples outlined below, the method may be performed by a location server in the wireless communication system.

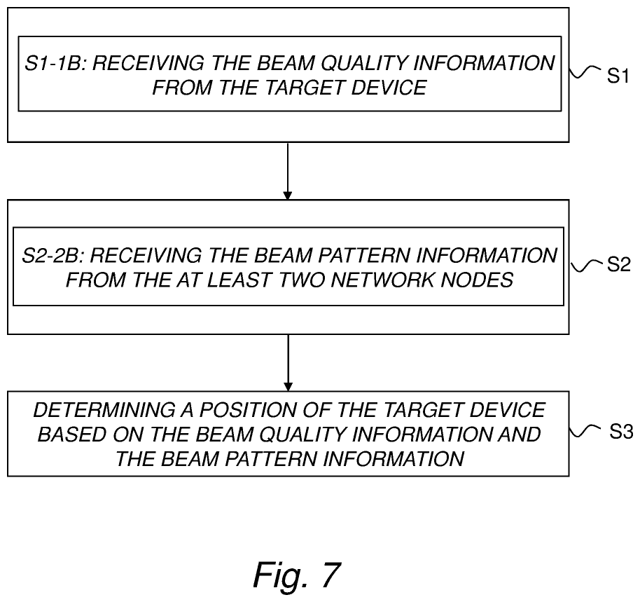

FIG. 7 is a schematic flow diagram illustrating yet another example of a method for positioning of a target device in a wireless communication system according to a specific embodiment.

In this example, the step S1 of obtaining beam quality information comprises receiving S1-1B the beam quality information from the target device, and the step S2 of obtaining beam pattern information comprises receiving S2-2B the beam pattern information from said at least two network nodes.

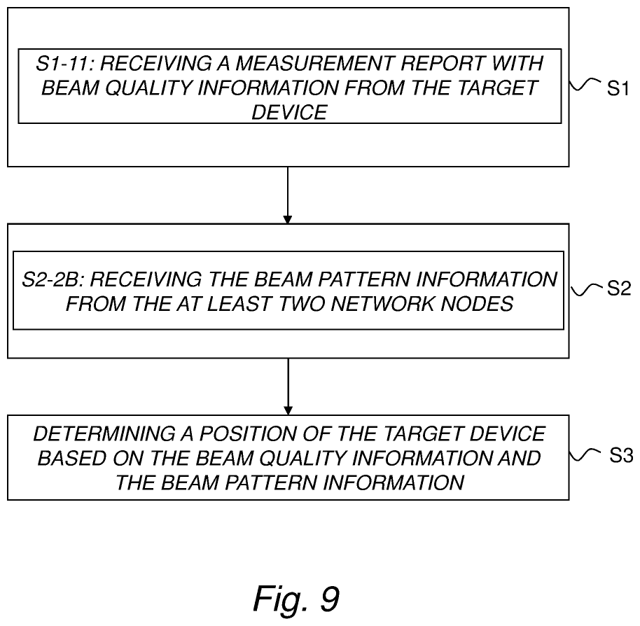

Optionally, as further outlined in FIG. 9, the step S1 of obtaining beam quality information comprises S1-11 receiving a measurement report with beam quality information from the target device comprising information representative of beam quality measurements relating to beams transmitted from multiple network nodes, and the beam pattern information is requested from a set of network nodes selected among those network nodes listed in the measurement report, wherein the specific beam patterns of the requested beam pattern information correspond in time to the beam quality measurements.

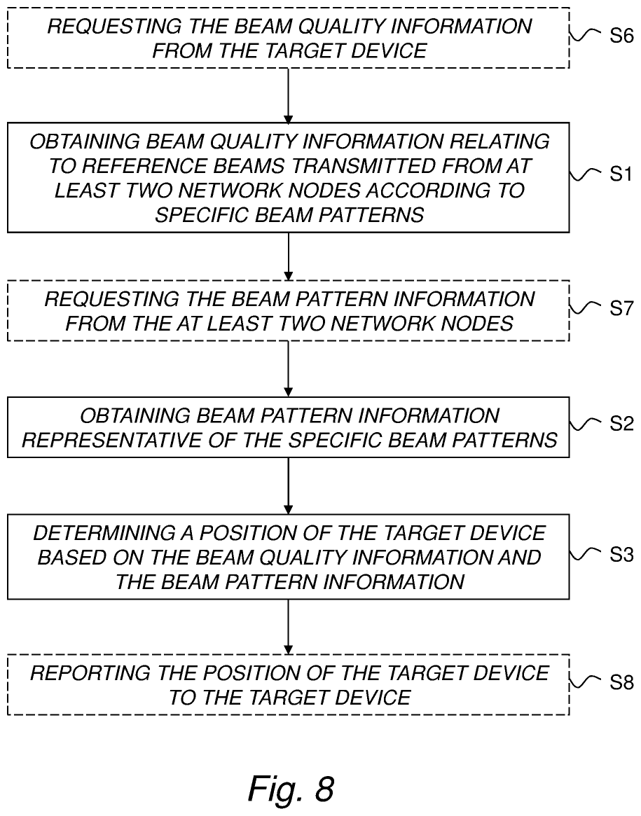

FIG. 8 is a schematic flow diagram illustrating still another example of a method for positioning of a target device in a wireless communication system according to a specific embodiment.

In this example, the method may further comprise requesting S6 the beam quality information from the target device and/or requesting S7 the beam pattern information from the at least two network nodes.

By way of example, the step S6 of requesting the beam pattern information may be performed before the step S7 of requesting the beam quality information, wherein the beam quality measurements of the requested beam quality information correspond in time to the specific beam patterns used when transmitting the reference beams.

Optionally, the method further comprises reporting S8 the position of the target device to the target device.

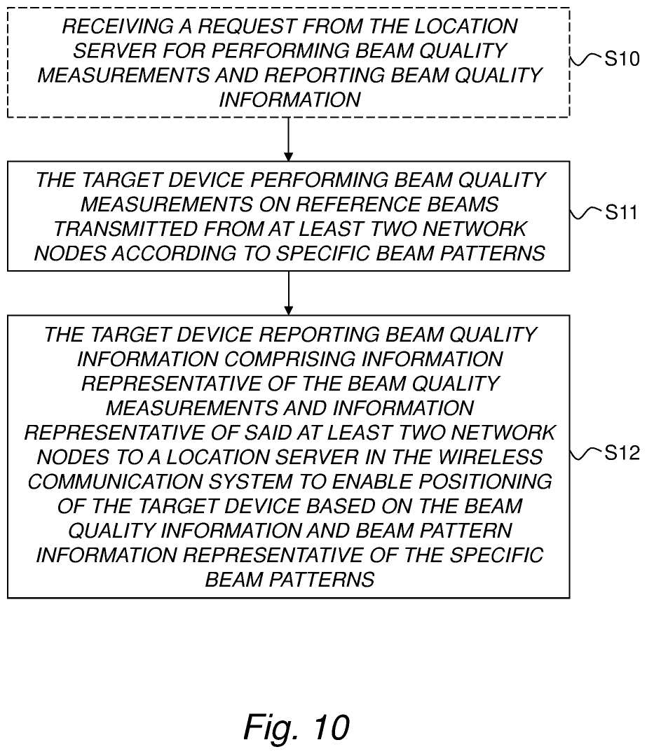

FIG. 10 is a schematic flow diagram illustrating an example of a method for assisting in the positioning of a target device in a wireless communication system. The method comprises the following steps:

S11: the target device performing beam quality measurements on reference beams transmitted from at least two network nodes according to specific beam patterns;

S12: the target device reporting beam quality information comprising information representative of the beam quality measurements and information representative of said at least two network nodes to a location server in the wireless communication system to enable positioning of the target device based on the beam quality information and beam pattern information representative of the specific beam patterns.

For example, the beam quality information may include information representative of Beam Reference Signal Received Power, BRSRP, and/or Beam Reference Signal Received Quality, BRSRQ.

By way of example, the beam quality information may be associated with beam identification information allowing identification of the reference beams.

For example, the beam pattern information may include information representative of main lobe, beam width and/or beam angle.

In a particular example, the beam pattern information for each reference beam corresponds to the specific beam pattern used at the time of measurement of the reference beam.

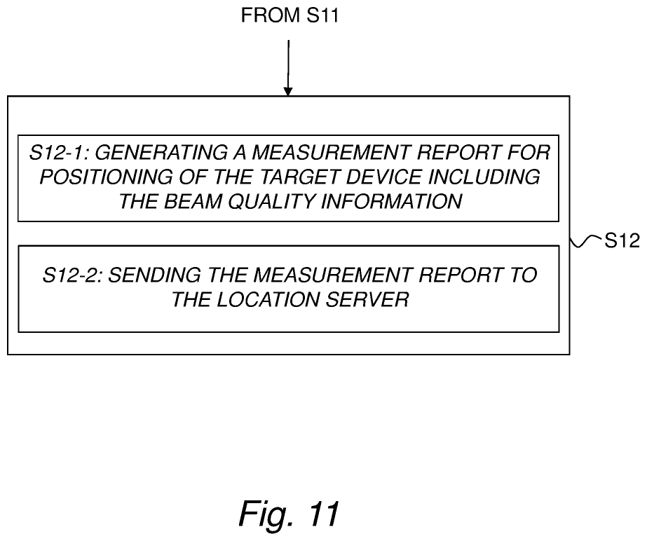

FIG. 11 is a schematic diagram illustrating an example of the step of the target device reporting beam quality information according to an embodiment. The step S12 of reporting comprises generating S12-1 a measurement report for positioning of the target device including the beam quality information and sending S12-2 the measurement report to the location server.

As an example, the beam quality information may be associated with time stamp information representative of the time of measurement of each reference beam.

As mentioned, the at least two network nodes may include, e.g. a serving network node of the target device and at least one neighboring network node.

Optionally, the method may further comprise receiving S10 a request from the location server for performing the beam quality measurements and reporting the beam quality information.

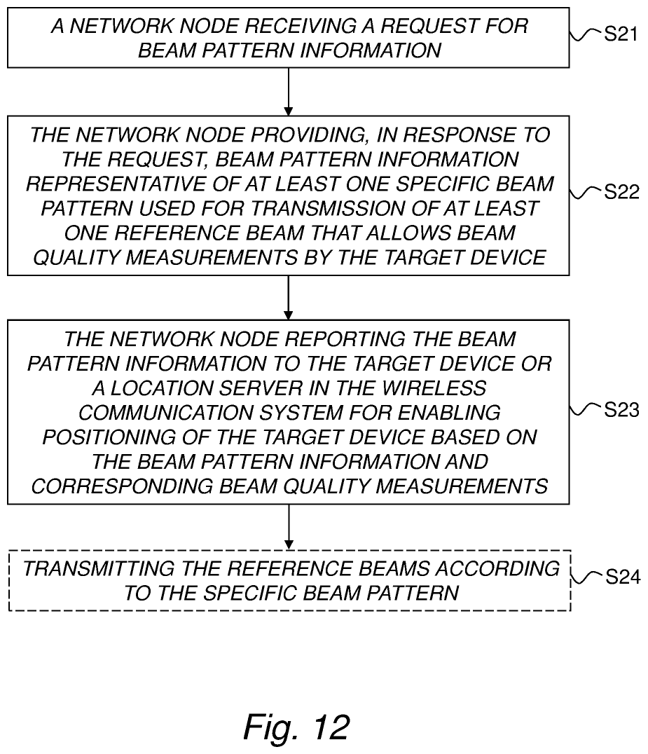

FIG. 12 is a schematic flow diagram illustrating an example of a method for assisting in the positioning of a target device in a wireless communication system. The method comprises the following steps:

S21: a network node receiving a request for beam pattern information;

S22: the network node providing, in response to the request, beam pattern information representative of at least one specific beam pattern used for transmission of at least one reference beam that allows beam quality measurements by the target device; and

S23: the network node reporting the beam pattern information to the target device or a location server in the wireless communication system for enabling positioning of the target device based on the beam pattern information and corresponding beam quality measurements.

Optionally, the method further comprises transmitting S24 the reference beams according to the specific beam pattern.

By way of example, the beam pattern information may include information representative of main lobe, beam width and/or beam angle.

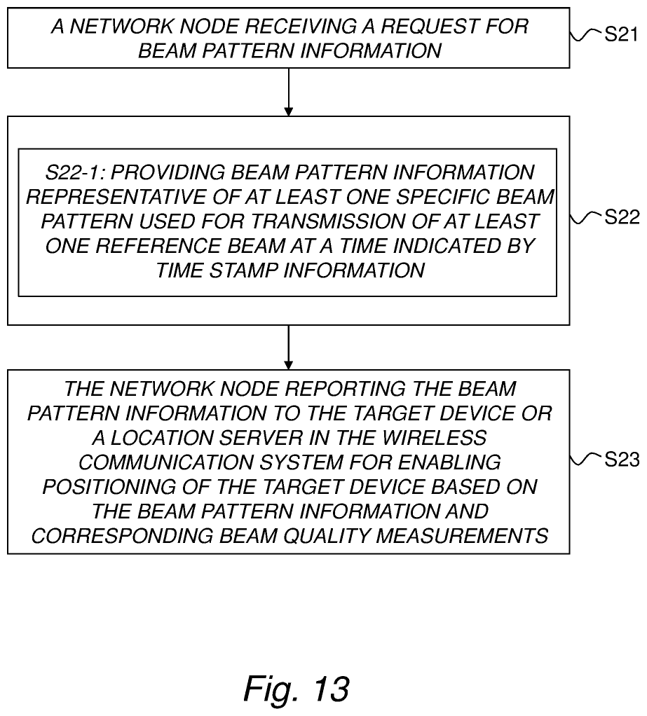

FIG. 13 is a schematic flow diagram illustrating another example of a method for assisting in the positioning of a target device in a wireless communication system. In this example, the request for beam pattern information comprises time stamp information, and the step S22 of providing beam pattern information comprises providing S22-1 beam pattern information representative of at least one specific beam pattern used for transmission of at least one reference beam at a time indicated by the time stamp information.

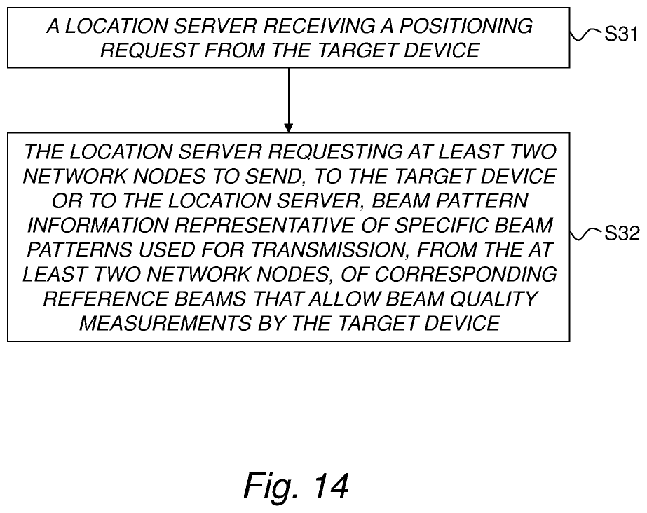

FIG. 14 is a schematic flow diagram illustrating an example of a method for assisting in the positioning of a target device in a wireless communication system. The method comprises the following steps:

S31: a location server receiving a positioning request from the target device; and

S32: the location server requesting at least two network nodes to send, to the target device or to the location server, beam pattern information representative of specific beam patterns used for transmission, from the at least two network nodes, of corresponding reference beams that allow beam quality measurements by the target device.

By way of example, the beam pattern information may be requested for a specific time as indicated by time stamp information.

For example, the beam pattern information for each reference beam may correspond to the specific beam pattern used at the time of the beam quality measurement of the reference beam.

As an example, the location server receives the requested beam pattern information and sends the beam pattern information to target device.

For example, the beam pattern information may include information representative of main lobe, beam width and/or beam angle.

In the following, the proposed technology will be described with reference to a set of non-limiting examples serving illustrative purposes only.

One of the probable considerations of the future positioning architecture is to have a location server unit in the core network, and to have a dedicated protocol on positioning between the target device and the location server. Certain aspects of the proposed technology may be used for introducing signaling and exchange of beam quality information including assistance information (e.g. time stamp of measurement) between such a location server and UE/network nodes (e.g. serving and neighboring network nodes). The location server has access to (e.g. by signaling from the serving and neighboring network nodes) beam pattern information and/or BRSRP-to-angle mapping algorithm for the serving and neighboring nodes. By way of example, this would allow multiple angle estimations between the UE and the nodes which leads to better positioning accuracy.

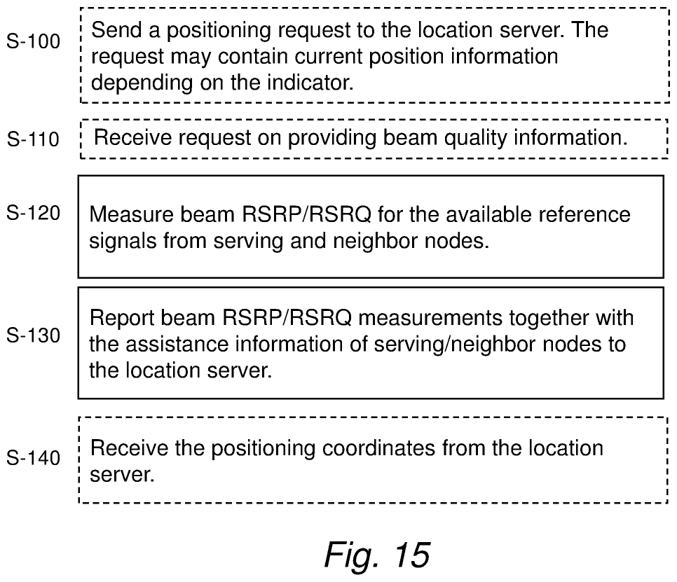

In order to exploit the beam information at the location server, two components may be useful: Beam pattern information and beam quality information. As an example, the beam quality information may include assistance information such as beam ID, reference signal information and time stamp. There are several different aspects and/or embodiments for realizing the objective of estimating the position of a target device and/or assisting such positioning. For example, there may be location-server-based and target-device-based implementations, e.g. depending on where the computation of position is selected to be performed. For each aspect and/or embodiment, the functions of the target device, network node and location server differ slightly. FIG. 15 to FIG. 27 illustrate non-limiting examples of some of the actions and/or steps of the proposed technology, as seen from the perspective of the target device, the network node(s) and the location server. Optional actions and/or steps are indicated by dashed boxes.

The examples illustrated in FIG. 15 to FIG. 21 refer to aspects and/or embodiments wherein the actual computation of the position is based in the location server and wherein the target device and/or the other network node(s) take(s) assistive actions in the overall positioning procedure.

FIG. 15 is a schematic flow diagram illustrating an example of actions and/or steps from the perspective of a target device according to a specific embodiment.

S-100: Send a positioning request to location server (optional).

S-110: Receive request on providing beam quality information (optional).

S-120: Measure beam RSRP/RSRQ (or similar).

S-130: Report beam RSRP/RSRQ (or similar info).

S-140: Receive position information such as positioning coordinates (optional).

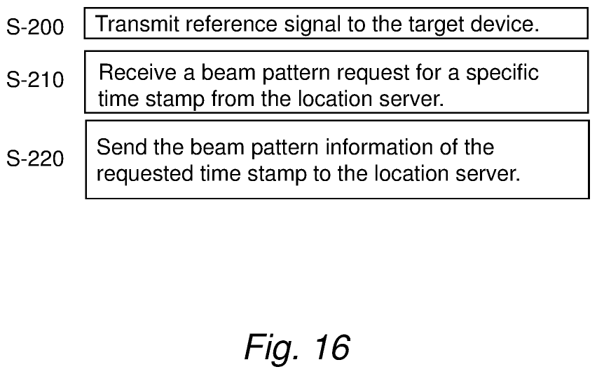

FIG. 16 is a schematic flow diagram illustrating an example of actions and/or steps from the perspective of a network node according to a specific embodiment.

S-200: Transmit reference signal.

S-210: Receive beam pattern request from location server.

S-220: Send beam pattern information to location server.

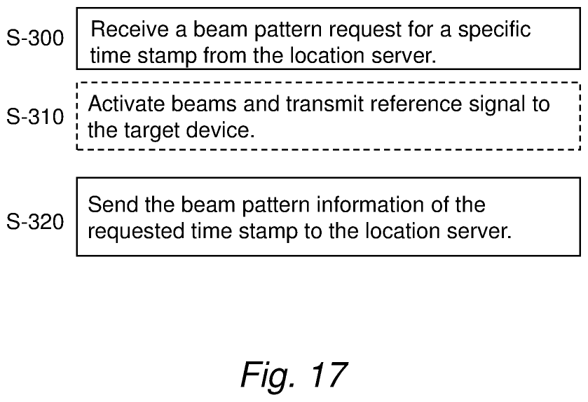

FIG. 17 is a schematic flow diagram illustrating an example of actions and/or steps from the perspective of a network node according to another specific embodiment.

S-300: Receive beam pattern request from location server.

S-310: Activate beams and transmit reference signal(s) (optional).

S-320: Send beam pattern information to location server.

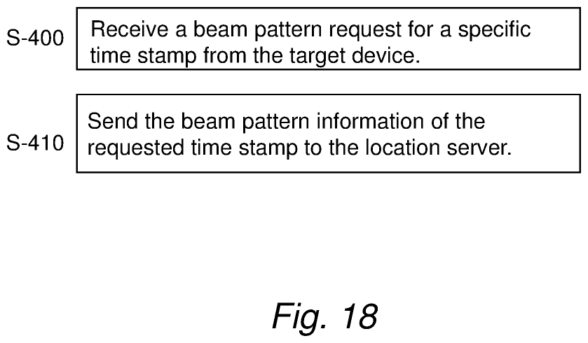

FIG. 18 is a schematic flow diagram illustrating an example of actions and/or steps from the perspective of a network node according to yet another specific embodiment.

S-400: Receive beam pattern request from target device.

S-410: Send beam pattern information to location server.

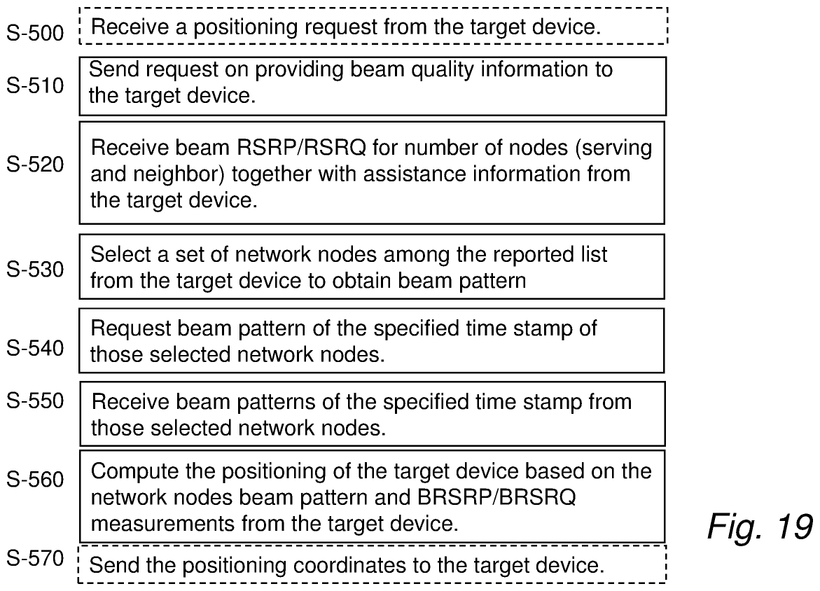

FIG. 19 is a schematic flow diagram illustrating an example of actions and/or steps from the perspective of a location server according to a specific embodiment.

S-500: Receive positioning request from target device (optional).

S-510: Send request on providing beam quality information to target device.

S-520: Receive beam RSRP/RSRQ (or similar info) from target device.

S-530: Select a set of network nodes.

S-540: Request beam pattern(s) of selected network nodes.

S-550: Receive beam pattern(s) from selected network nodes.

S-560: Compute positioning of target device.

S-570: Send position information such as positioning coordinates to target device (optional).

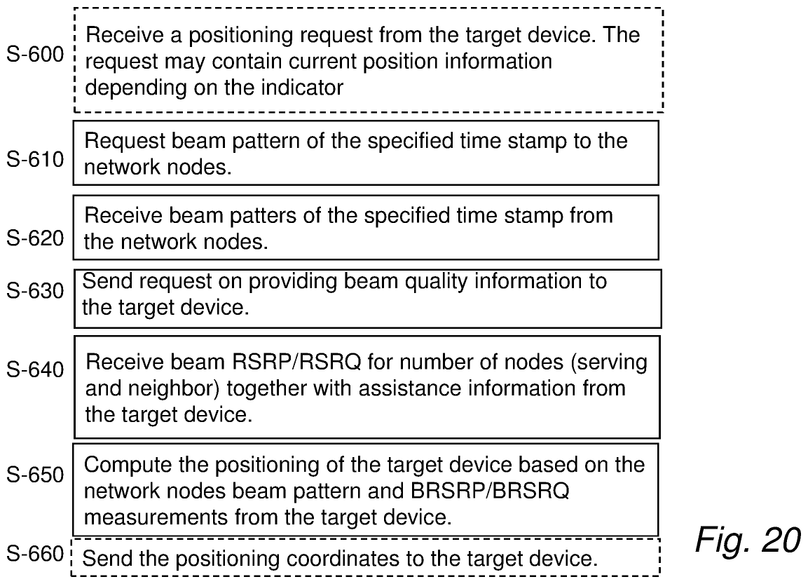

FIG. 20 is a schematic flow diagram illustrating an example of actions and/or steps from the perspective of a location server according to another specific embodiment.

S-600: Receive positioning request from target device (optional).

S-610: Request beam pattern.

S-620: Receive beam pattern.

S-630: Send request on providing beam quality information to target device.

S-640: Receive beam RSRP/RSRQ (or similar info) from target device.

S-650: Compute positioning of target device.

S-660: Send position information such as positioning coordinates to target device (optional).

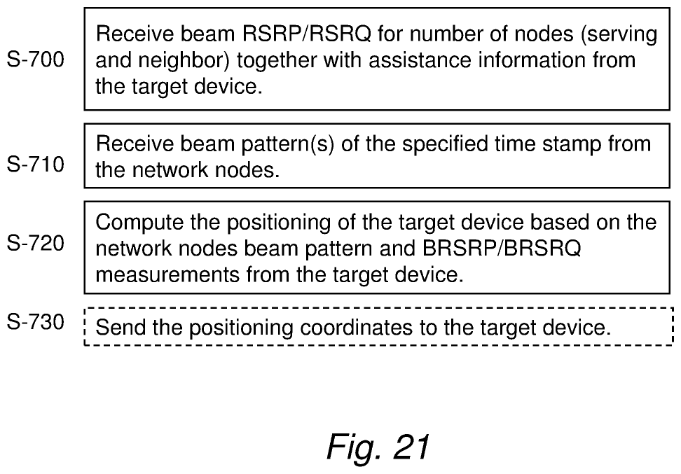

FIG. 21 is a schematic flow diagram illustrating an example of actions and/or steps from the perspective of a location server according to yet another specific embodiment.

S-700: Receive beam RSRP/RSRQ (or similar info)

S-710: Receive beam pattern(s).

S-720: Compute positioning of target device.

S-730: Send position information such as positioning coordinates to target device (optional).

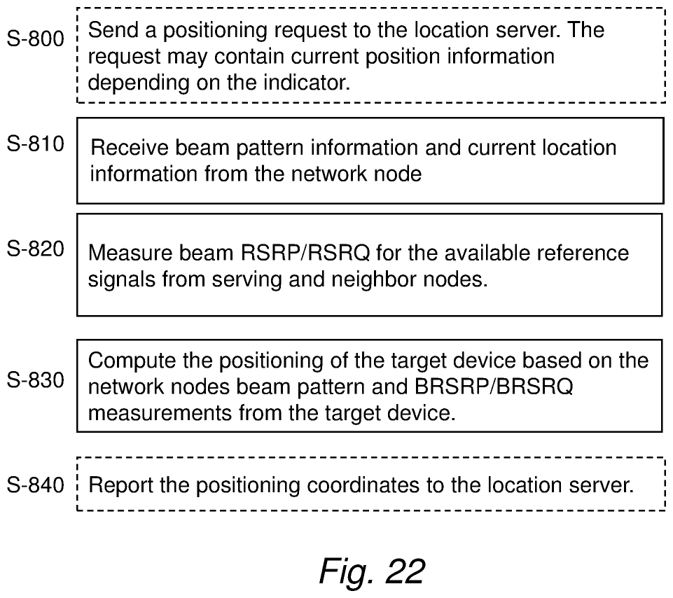

The examples illustrated in FIG. 22 to FIG. 27 refer to aspects and/or embodiments wherein the actual computation of the position is based in the target device and wherein the location server and/or the other network node(s) take(s) assistive actions in the overall positioning procedure.

FIG. 22 is a schematic flow diagram illustrating an example of actions and/or steps from the perspective of a target device according to a specific embodiment.

S-800: Send positioning request to location server (optional).

S-810: Receive beam pattern information from network node.

S-820: Measure beam RSRP/RSRQ (or similar).

S-830: Compute positioning of target device.

S-840: Report position information such as positioning coordinates to location server (optional).

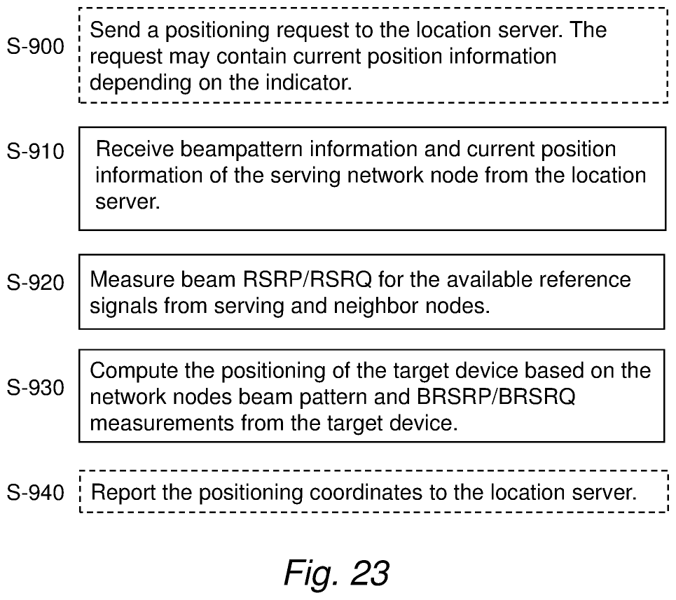

FIG. 23 is a schematic flow diagram illustrating an example of actions and/or steps from the perspective of a target device according to another specific embodiment.

S-900: Send positioning request to location server (optional).

S-910: Receive beam pattern information from location server.

S-920: Measure beam RSRP/RSRQ (or similar).

S-930: Compute positioning of target device.

S-940: Report position information such as positioning coordinates to location server (optional).

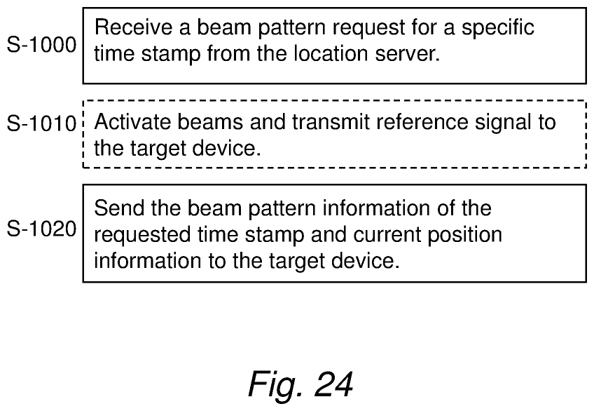

FIG. 24 is a schematic flow diagram illustrating an example of actions and/or steps from the perspective of a network node according to a specific embodiment.

S-1000: Receive beam pattern request from location server.

S-1010: Activate beams and transmit reference signals (optional).

S-1020: Send beam pattern information to target device.

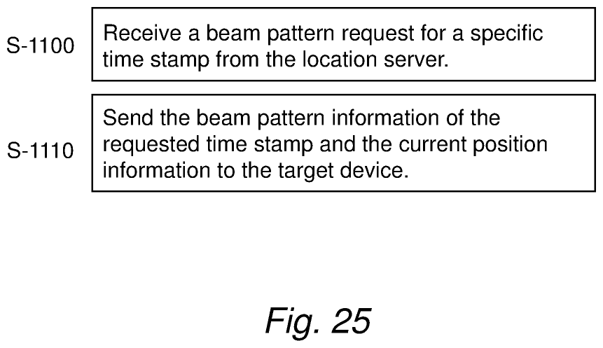

FIG. 25 is a schematic flow diagram illustrating an example of actions and/or steps from the perspective of a network node according to another specific embodiment.

S-1100: Receive beam pattern request from location server.

S-1110: Send beam pattern information to target device.

In this example, the beams have already been transmitted and/or are to be transmitted at a later specified time.

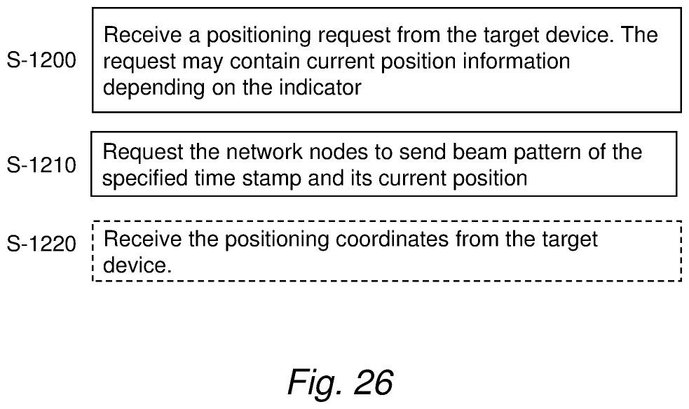

FIG. 26 is a schematic flow diagram illustrating an example of actions and/or steps from the perspective of a location server according to a specific embodiment.

S-1200: Receive positioning request from target device.

S-1210: Request the network nodes to send beam pattern.

S-1220: Receive position information such as positioning coordinates from target device (optional).

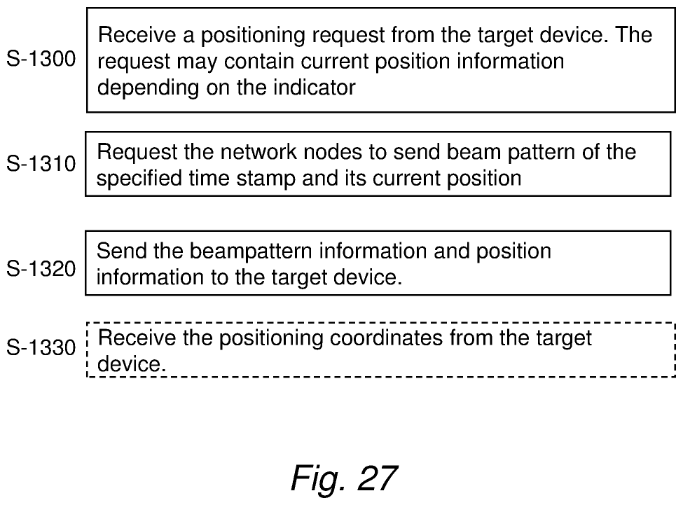

FIG. 27 is a schematic flow diagram illustrating an example of actions and/or steps from the perspective of a location server according to another specific embodiment.

S-1300: Receive positioning request from target device.

S-1310: Request the network nodes to send beam pattern.

S-1320: Send beam pattern information to target device.

S-1330: Receive position information such as positioning coordinates from target device (optional).

The proposed technology provides better positioning accuracy because of one or more of the following features:
Angles estimation from multiple nodes are considered.
The network node selects the desired beam configuration for optimal angular estimation
In comparison to LTE, it is possible to reduce the positioning error in scale of a beam coverage by BRSRPs, compared to cell coverage with RSRP measurements. The solution is scalable to a dynamic beam pattern design in which the network node may have dynamic change in size of the beam and its configuration.
High performance base stations such as NR base stations are expected to have significantly more antennas in comparison to LTE base stations, and this will lead to higher angular estimation accuracy and larger potential positioning gains in NR compared to LTE.

In the following, non-limiting examples of some of the concepts and features that may be useful in the overall positioning procedure(s) will now be discussed:

Positioning Request

The location server receives a positioning request from either another core unit or optionally from the target device. This request may contain current position information depending on the indicator.

Beam Quality Information Request

The location server sends this signaling request in order to obtain the beam RSRP/RSRQ (i.e. BRSRP/BRSRQ) of a set of highest quality beams at the target device. In the request, the location server may indicate the maximum number of required measurements from the target device. The signaling request may also comprise information of the reference signals for beam measurements. For example, the location of the time-frequency resources for the said reference signals.

The beam quality information may also include assistance information such as:
The time stamp of when the beam was measured
Beam ID, Cell ID and/or node ID
Reference Signal Information

Target Device Measurement

The target device mainly when it is in connected mode periodically, or on demand measures the BRSRP/BRSRQ of the surrounding network nodes to provide efficient mobility. Similar approach is used here, meaning that when the target device receives the request from the location server, it provides a set of beams with corresponding BRSRP/BRSRQ, in one embodiment, the set is the beams with highest BRSRP/BRSRQ. As the network nodes which transmit those reference signals may dynamically change their beam pattern, it is important that the target device also consider the time at which the beam measurements are done, and that the network node stores the beam pattern information for the said time instance.

By way of example, the reference signal may be Primary, Secondary Synchronization Signals PSS/SSS or Channel State Information-Reference Signal (CSI-RS).

Beam Quality Information Report

The target device sends all the beam quality information in one report to the location server. The report contains a list of beams which may be from both the serving node or one or more neighbor nodes. For each beam the report data may comprise:
Beam ID/Cell ID/Node ID
BRSRP/BRSRQ, this comprises the beam RSRP or/and RSRQ for each beam. In one embodiment, the RSRP/RSRQ is reported as a RSRP difference to a reference beam, for example the strongest beam. It is possible to estimate the angle based on the difference, and reporting the difference is more efficient in terms of signaling bits.
Time stamp
Reference signal information

Selection of the Network Nodes

In order for the location server to compute the positioning of the target device based on the beam measurement information, the location sever needs to collect the beam pattern information of the reported network nodes. Here are the steps the location server performs at this stage:
Indicates the number of different network nodes in which the target device has sent beam information
For each indicated network node, collecting the beams considered and the time stamps
Preparing a beam pattern request for each of those network nodes

Beam Pattern Request

The location server sends one (i.e. serving node) or more (i.e. set of neighbor nodes) requests for beam pattern of certain time stamp and reference signal measured by the target device. Here we have considered a similar approach for both the serving node and the neighboring node, however, in another embodiment the neighbor node may consider less prioritization in responding to this request. As an example, the beam pattern information may include:
Main lobe
Grating lobe
Beam width

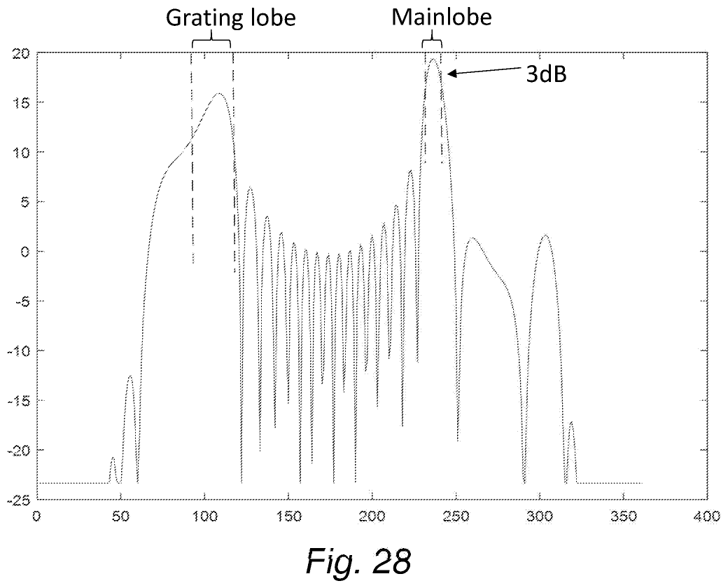

FIG. 28 is a schematic diagram illustrating an example of a beam pattern for a specific beam.

In a directional antenna in which the objective is to emit the radio waves in one direction, the lobe in that direction has a larger field strength than the others; this is the “main lobe”. The other lobes are called “side lobes”, and usually represent unwanted radiation in undesired directions. Grating lobes are a special case of a side lobe. In such a case, the side lobes should be considered all the lobes lying between the main lobe and the first grating lobe, or between grating lobes. It is conceptually useful to distinguish between side lobes and grating lobes because grating lobes have larger amplitudes than most, if not all, of the other side lobes. The term beam width is the half power beam width of the point where is (−3 dB) below the peak of main lobe. Beam width is usually but not always expressed in degrees and for the horizontal plane.

As shown in FIG. 28, by providing the information about the beam width, main lobe and grating lobe directions, it is possible to communicate the beam pattern to the location server, in which the AoD can be computed based on advanced algorithms. In one embodiment, the beam pattern also includes the width of the main and grating lobe, for example the angels where the antenna gain is larger than a threshold with respect to the peak of the grating/main lobe.

In an example embodiment, the beam pattern comprises the antenna gain for each angle, that is, reporting each data point in FIG. 28. In another embodiment, the beam pattern corresponds to reporting all angels and antenna gain where the said gain is above a threshold.

Angle of Departure (AoD) Estimation

At the location server or device based on the BRSRP/BRSRQ and the obtained beam pattern from each network node it is possible to compute the Angle of Departure (AoD) of the reference signal of each network node. This can be done by algorithms, such as MUSIC.

As the beams are both horizontally and vertically distributed the AoD can be computed both on the horizontal axis (covering the azimuth) or also at the vertical axis (covering the tilt of the antenna). The angle for the vertical can be referenced by a line perpendicular to the ground level, and the angle for horizontal can be defined referring to its relation to the North of the geographical location.

Positioning Estimation at the Location Server

The network nodes' location coordinates and heights are available at the location server, and while having the AoD of several different beams from two or more nodes that are not on the same geographical coordinates, it is possible to compute the position. In case the positioning request was sent from the target device this estimation can be reported to the target device or any other node from which the request has been sent.

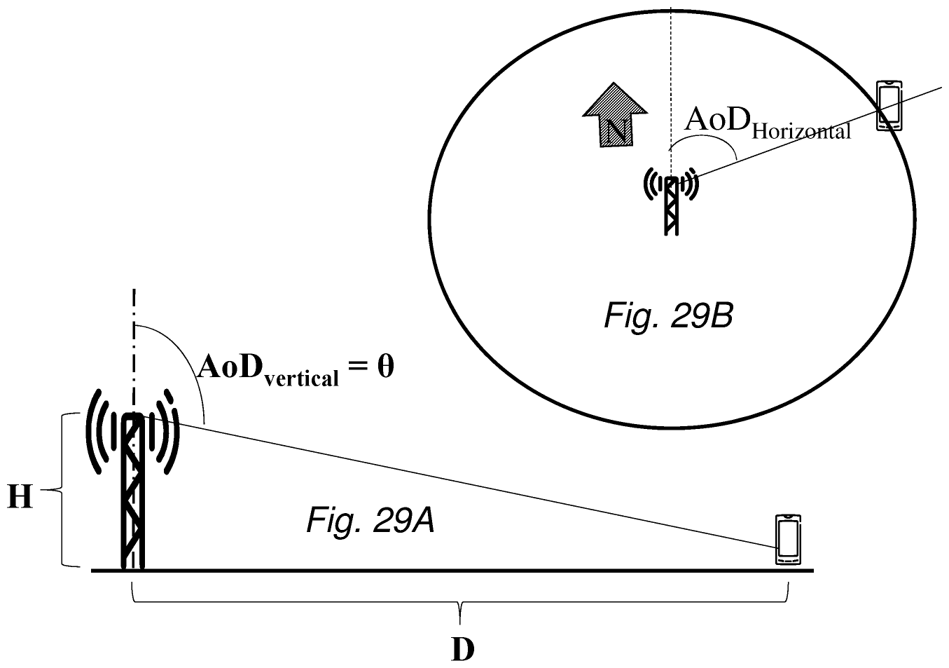

By computing the vertical AoD, it is possible to compute the distance (D) between the target device and the network node if considering the UE is at ground level (i.e. D=H×tan(π−θ)). With the horizontal AoD, it is possible to estimate the position of the UE in correspondence to a point on the circle with the estimated distance from the network node. FIG. 29A and FIG. 29B illustrate positioning obtained by vertical and horizontal AoD, respectively. When computing these two parameters from several network node it is possible to compute the position coordinates of the target device with a very good accuracy.

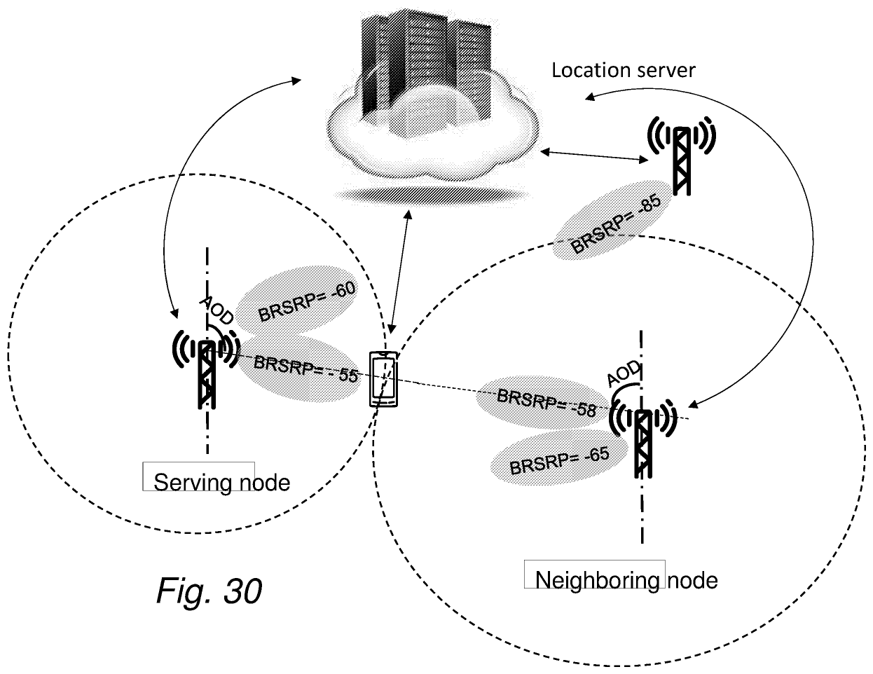

FIG. 30 is a schematic diagram illustrating a non-limiting example of positioning procedure(s) and components that may be involved in the proposed technology. Multiple beams may be formed at the network node. In this example, BRSRP values are constantly measured with the beam signal from the serving network node, and the neighboring node at the UE. BRSRP values will typically have higher value at the serving network node. Second highest value in the second neighboring network node. As the network node go further from the UE, the recorded BRSRP value will be lower. The location server obtains information about BRSRP values from the UE and beam pattern information from the serving node, and neighboring node (perhaps, more than one). Using advanced algorithm, an angular position estimate can be determined at the location server. The dashed line indicate the determination of position by angular information obtained from multiple network node using multi-lateration techniques.

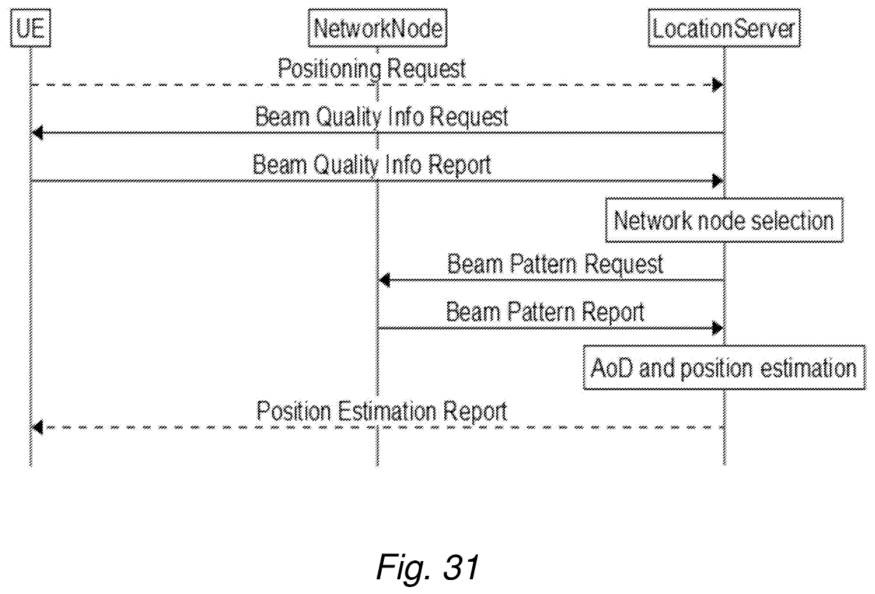

In the following, non-limiting examples of different aspects and/or embodiments of the proposed technology will be described with reference to the signaling and/or action diagrams of FIG. 31 to FIG. 36. Dashed lines indicate optional features.

FIG. 31 is a schematic signaling and/or action diagram illustrating an example of the proposed technology according to an embodiment.

In this example, a UE sends positioning request to the location server. Upon receiving the request, location server sends a Beam Quality Info Request to the UE, UE respond to the location server by sending Beam Quality Info Report. With the beam quality info report, location server conduct network node selection procedure as described in this invention. With the selected nodes, the location server sends the Beam Pattern Request, and receive the Beam Pattern Report from the selected network node. Location server then perform AoD and position estimation and sends the Position Estimation Report back to the UE.

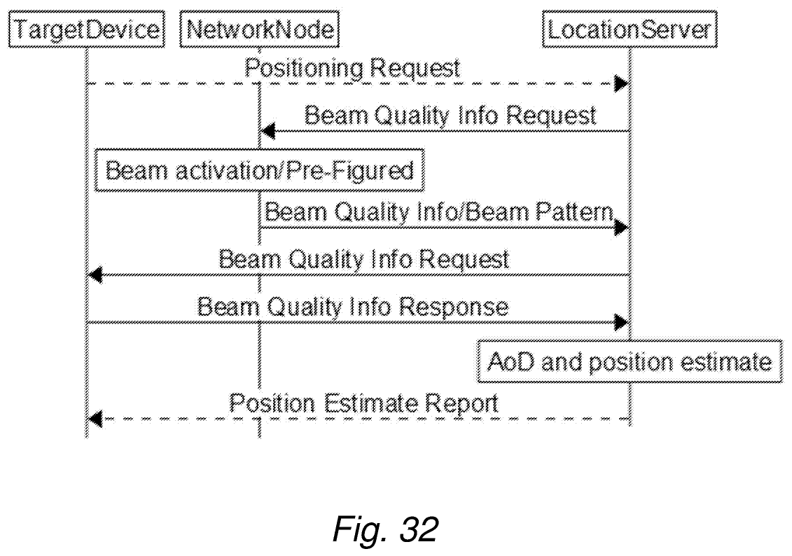

FIG. 32 is a schematic signaling and/or action diagram illustrating an example of the proposed technology according to another embodiment.

In this example, the target device sends a positioning request to the location Server, optionally with current position information depending on the indicator. The location Server then sends request to the network node for beam quality info report which may contains information on beam ID etc. Upon receiving the request, network node optionally activates the beam and sends beam quality info response and beam pattern back to the location server. The location server also sends beam quality info request to the target device, and receive the response from the target device. It then estimates the position, and optionally sends the position estimate report back to the target device.

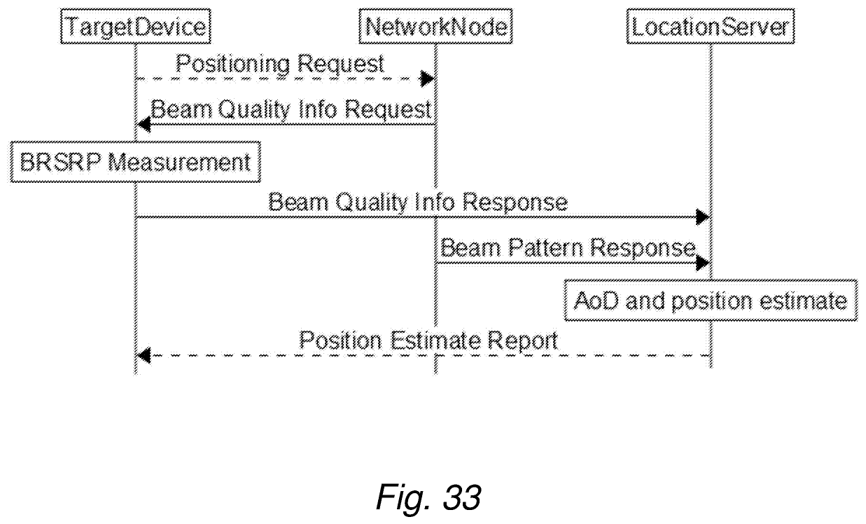

FIG. 33 is a schematic signaling and/or action diagram illustrating an example of the proposed technology according to yet another embodiment.

In this example, the target device sends the positioning request to the network node, then receives a beam quality info request from the network node. The target device will perform BRSRP measurement and reports this back to the location server as beam quality info response. Network node will also send a beam pattern response to the location server. With all these information, the location server will perform AoD and position estimate. Finally, a position estimate report is sent back to the target device optionally.

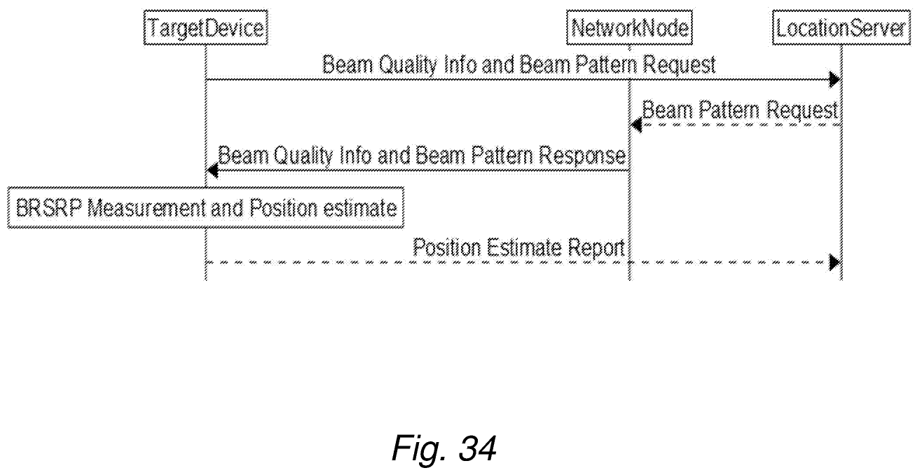

FIG. 34 is a schematic signaling and/or action diagram illustrating an example of the proposed technology according to still another embodiment.

In this example, the target device interacts with the location server to request beam quality info and beam pattern. Optionally, the location server request the network node to send beam pattern and beam quality info to the target device. The target device perform BRSRP measurement and compute the position estimate. It optionally send the position estimate report back to the location server.

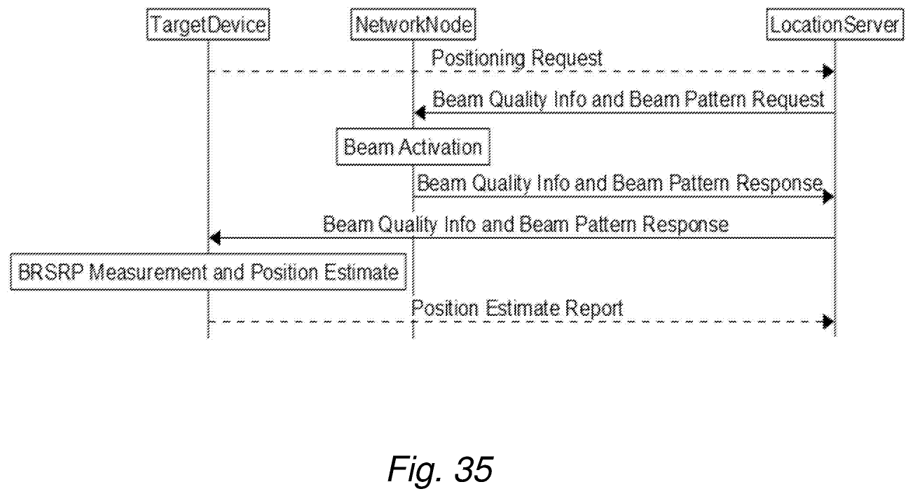

FIG. 35 is a schematic signaling and/or action diagram illustrating an example of the proposed technology according to yet another embodiment.

In this example, the target device sends a positioning request to the location server. The location server then request beam quality info and beam patter from the network node. Beams are activated upon request and beam quality info and beam pattern is sent back as a response to the location server. The location server sends the beam quality info and beam pattern response back to the target device. The target device will perform BRSRP measurement and estimate position, finally, optionally, the position estimate is sent back to the location server.

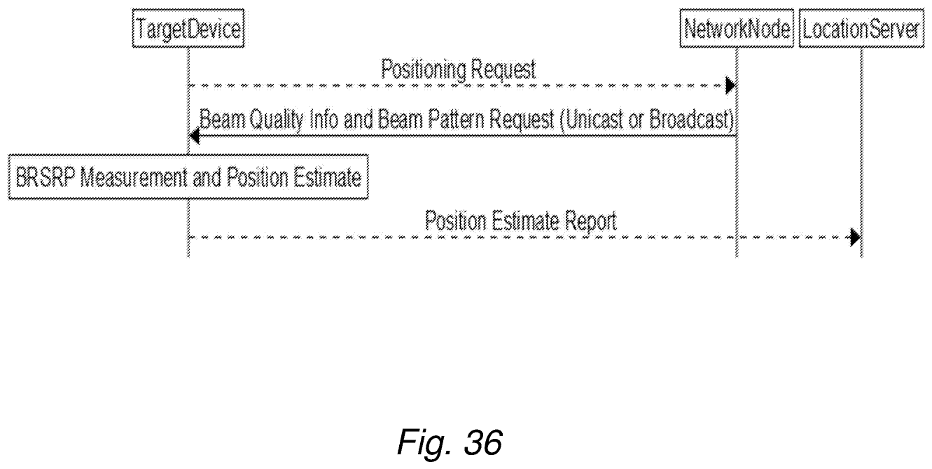

FIG. 36 is a schematic signaling and/or action diagram illustrating an example of the proposed technology according to another embodiment.

In this example, the target device sends the positioning request to the network node. Upon request, the network node respond with beam quality info and beam pattern information. These can be sent via unicast or broadcast channel. The target device measure BRSRP values, and estimate the position. Optionally, it sends back the position estimate to the location server.

In a sense, a basic idea is to exploit target device measurements of reference beams from two or more nodes with different geographical location in order to compute useful information such as the AoD of the reference beams at those network nodes, and to further use this information for positioning estimation.

It will be appreciated that the methods and arrangements described herein can be implemented, combined and re-arranged in a variety of ways.

For example, embodiments may be implemented in hardware, or in software for execution by suitable processing circuitry, or a combination thereof.

The steps, functions, procedures, modules and/or blocks described herein may be implemented in hardware using any conventional technology, such as discrete circuit or integrated circuit technology, including both general-purpose electronic circuitry and application-specific circuitry.

Alternatively, or as a complement, at least some of the steps, functions, procedures, modules and/or blocks described herein may be implemented in software such as a computer program for execution by suitable processing circuitry such as one or more processors or processing units.

Examples of processing circuitry includes, but is not limited to, one or more microprocessors, one or more Digital Signal Processors (DSPs), one or more Central Processing Units (CPUs), video acceleration hardware, and/or any suitable programmable logic circuitry such as one or more Field Programmable Gate Arrays (FPGAs), or one or more Programmable Logic Controllers (PLCs).

The actual hardware-software partitioning can be decided by a system designer based on a number of factors including processing speed, cost of implementation and other requirements.

It should also be understood that it may be possible to re-use the general processing capabilities of any conventional device or unit in which the proposed technology is implemented. It may also be possible to re-use existing software, e.g. by reprogramming of the existing software or by adding new software components.

According to an aspect, there is provided a device configured to determine a position of a target device in a wireless communication system. The device is configured to obtain beam quality information relating to reference beams transmitted from at least two network nodes according to specific beam patterns. The device is further configured to obtain beam pattern information representative of the specific beam patterns. The device is also configured to determine a position of the target device based on the beam quality information and the beam pattern information.

In a particular example, the device may be configured to obtain the beam quality information by performing beam quality measurements on the reference beams, and the device may also be configured to obtain the beam pattern information by receiving the beam pattern information from the wireless communication system.

In another example, the device may be configured to obtain the beam quality information by receiving the beam quality information from the target device, and the device is configured to obtain the beam pattern information by receiving the beam pattern information from said at least two network nodes.

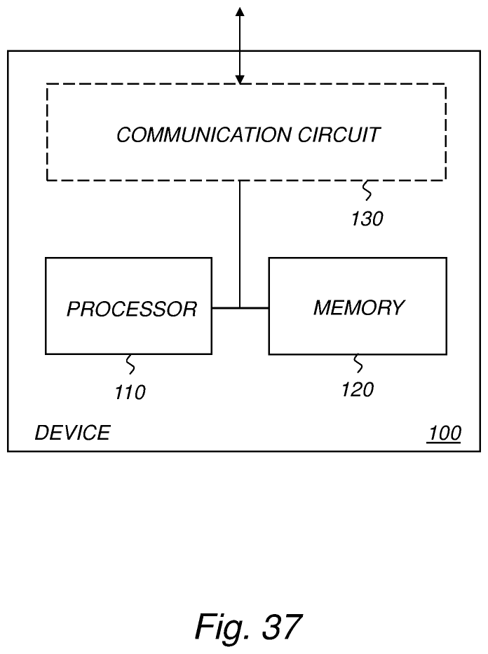

FIG. 37 is a schematic block diagram illustrating an example of a device configured to determine a position of a target device in a wireless communication system, based on a processor-memory implementation according to an embodiment.

In this particular example, the device 100 comprises a processor 110 and a memory 120, the memory 120 comprising instructions, which when executed by the processor, cause the processor to determine the position of the target device.

The device 100 may also include a communication circuit 130. The communication circuit 130 may include functions for wireless communication with other network units and/or devices in the network. In a particular example, the communication circuit 130 may be based on radio circuitry for communication with one or more other nodes, including transmitting and/or receiving information. The communication circuit 130 may be interconnected to the processor 110 and/or memory 120. By way of example, the communication circuit 130 may include any of the following: a receiver, a transmitter, a transceiver, input/output (I/O) circuitry, input port(s) and/or output port(s).

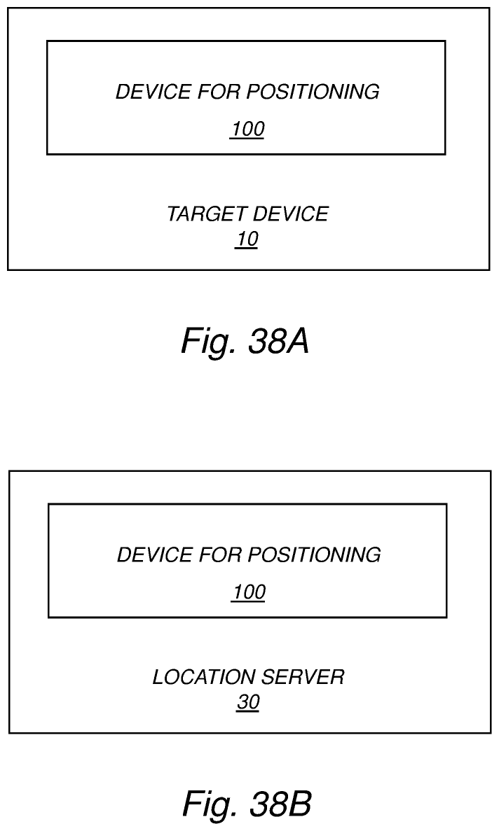

FIG. 38A is a schematic block diagram illustrating an example of a target device 10 comprising the device 100 for positioning.

FIG. 38B is a schematic block diagram illustrating an example of a location server 30 comprising the device 100 for positioning.

According to another aspect, there is provided a device configured to assist in the positioning of a target device in a wireless communication system. The device is configured to perform beam quality measurements on reference beams transmitted from at least two network nodes according to specific beam patterns. The device is also configured to report beam quality information comprising information representative of the beam quality measurements and information representative of the at least two network nodes to a location server in the wireless communication system to enable positioning of the target device based on the beam quality information and beam pattern information representative of the specific beam patterns.

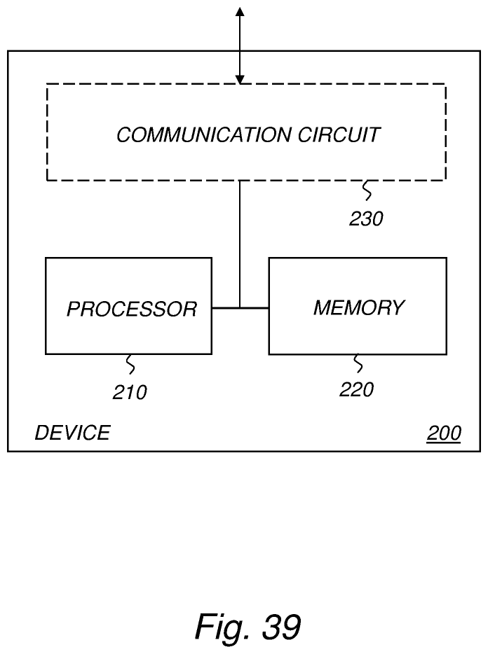

FIG. 39 is a schematic block diagram illustrating an example of a device configured to assist in the positioning of a target device in a wireless communication system, based on a processor-memory implementation according to an embodiment.

In this particular example, the device 200 comprises a processor 210 and a memory 220, the memory 220 comprising instructions, which when executed by the processor, cause the processor to assist in the positioning of the target device. Optionally, the device 200 may also include a communication circuit 230.

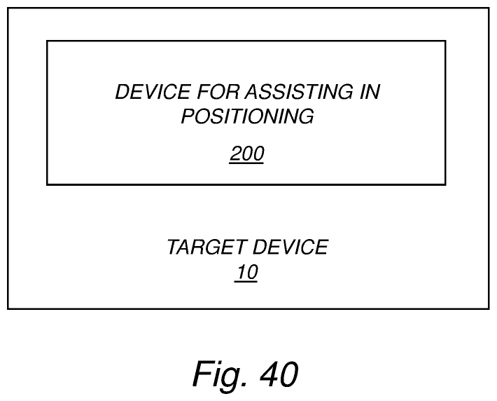

FIG. 40 is a schematic block diagram illustrating an example of a target device 10 comprising the device 200 for assisting in the positioning of the target device.

According to yet another aspect, there is provided a network node configured to assist in the positioning of a target device in a wireless communication system. The network node is configured to receive a request for beam pattern information. The network node is also configured to provide, in response to the request, beam pattern information representative of at least one specific beam pattern used for transmission of at least one reference beam that allows beam quality measurements by the target device. The network node is further configured to report the beam pattern information to the target device or a location server in the wireless communication system for enabling positioning of the target device based on the beam pattern information and corresponding beam quality measurements.

By way of example, the request for beam pattern information comprises time stamp information, and the network node may be configured to provide beam pattern information by providing beam pattern information representative of at least one specific beam pattern used for transmission of at least one reference beam at a time indicated by the time stamp information.

For example, the network node may be configured to transmit the reference beams according to the specific beam pattern.

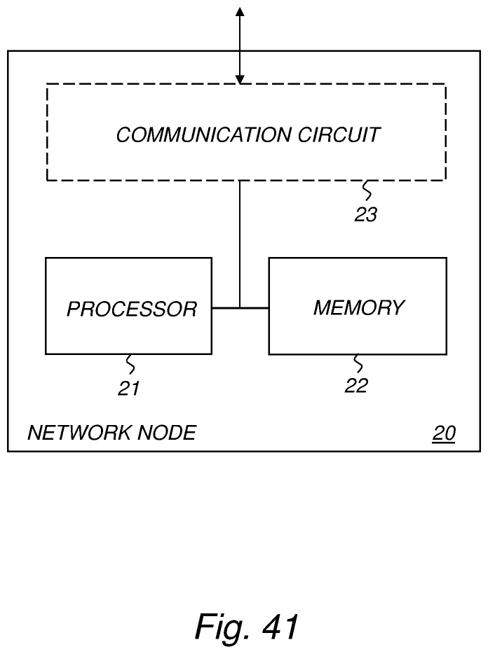

FIG. 41 is a schematic block diagram illustrating an example of a network node configured to assist in the positioning of a target device in a wireless communication system, based on a processor-memory implementation according to an embodiment.

In this particular example, the network node 20 comprises a processor 21 and a memory 22, the memory 22 comprising instructions, which when executed by the processor, cause the processor to assist in the positioning of the target device. The network node 20 may also include a communication circuit 23.

According to still another aspect, there is provided a location server configured to assist in the positioning of a target device in a wireless communication system. The location server is configured to receive a positioning request from the target device. The location server is also configured to request at least two network nodes to send, to the target device or to the location server, beam pattern information representative of specific beam patterns used for transmission, from the at least two network nodes, of corresponding reference beams that allow beam quality measurements by the target device.

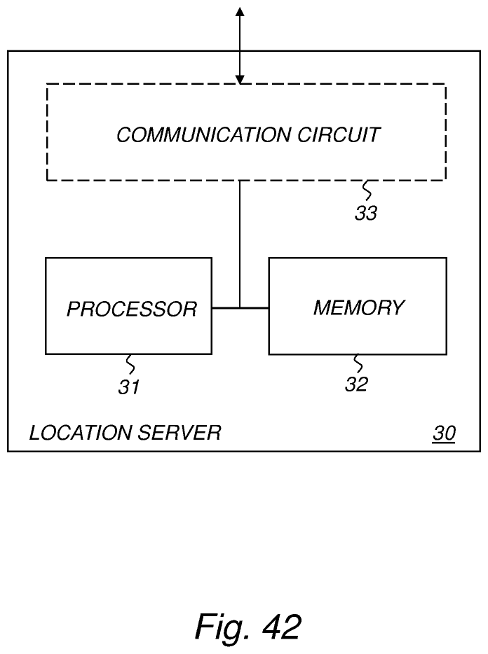

FIG. 42 is a schematic block diagram illustrating an example of a location server configured to assist in the positioning of a target device in a wireless communication system, based on a processor-memory implementation according to an embodiment.

In this particular example, the location server 30 comprises a processor 31 and a memory 32, the memory 32 comprising instructions, which when executed by the processor, cause the processor to assist in the positioning of the target device. The location server 30 may also include a communication circuit 33.

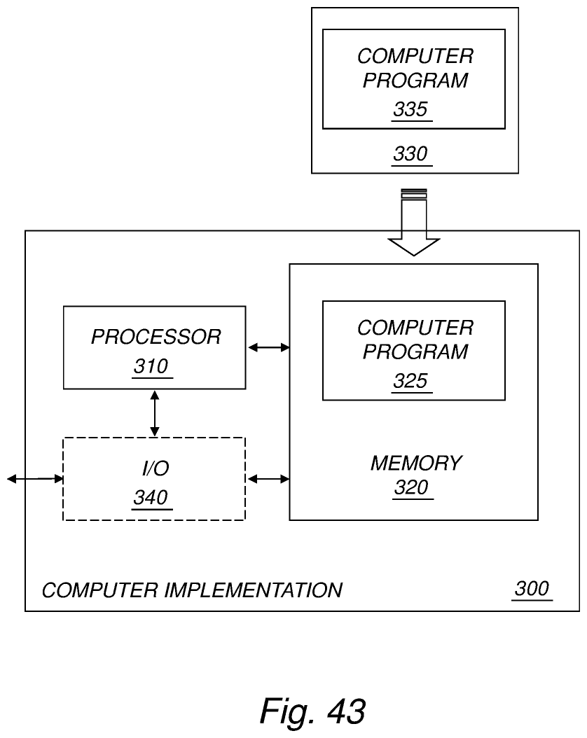

FIG. 43 is a schematic diagram illustrating an example of a computer-implementation 300 according to an embodiment. In this particular example, at least some of the steps, functions, procedures, modules and/or blocks described herein are implemented in a computer program 325; 335, which is loaded into the memory 320 for execution by processing circuitry including one or more processors 310. The processor(s) 310 and memory 320 are interconnected to each other to enable normal software execution. An optional input/output device 340 may also be interconnected to the processor(s) 310 and/or the memory 320 to enable input and/or output of relevant data such as input parameter(s) and/or resulting output parameter(s).

The term ‘processor’ should be interpreted in a general sense as any system or device capable of executing program code or computer program instructions to perform a particular processing, determining or computing task.

The processing circuitry including one or more processors 310 is thus configured to perform, when executing the computer program 325, well-defined processing tasks such as those described herein.

The processing circuitry does not have to be dedicated to only execute the above-described steps, functions, procedure and/or blocks, but may also execute other tasks.

In a particular embodiment, the computer program 325; 335 comprises instructions, which when executed by at least one processor 310, cause the processor(s) 310 to perform the actions described herein.

According to an aspect, there is provided a computer program 325, 335 comprising instructions, which when executed by at least one processor 310, cause the at least one processor 310 to:
obtain beam quality information relating to reference beams transmitted from at least two network nodes according to specific beam patterns;
obtain beam pattern information representative of the specific beam patterns; and
determine a position of a target device based on the beam quality information and the beam pattern information.

According to another aspect, there is provided a computer program 325, 335 comprising instructions, which when executed by at least one processor 310, cause the at least one processor 310 to:
control a target device to perform beam quality measurements on reference beams transmitted from at least two network nodes according to specific beam patterns; and
provide a report on beam quality information comprising information representative of the beam quality measurements and information representative of said at least two network nodes for transmission to a location server in the wireless communication system to enable positioning of the target device based on the beam quality information and beam pattern information representative of the specific beam patterns.

According to yet another aspect, there is provided a computer program 325, 335 comprising instructions, which when executed by at least one processor 310, cause the at least one processor 310 to:
receive a request for beam pattern information;
provide, in response to the request, beam pattern information representative of at least one specific beam pattern used for transmission of at least one reference beam that allows beam quality measurements by a target device; and
provide a report on the beam pattern information for transmission to the target device or a location server in the wireless communication system for enabling positioning of the target device based on the beam pattern information and corresponding beam quality measurements.

According to still another aspect, there is provided a computer program 325, 335 comprising instructions, which when executed by at least one processor 310, cause the at least one processor 310 to:
receive a positioning request from a target device; and
request at least two network nodes to send, to the target device or to a location server, beam pattern information representative of specific beam patterns used for transmission, from said at least two network nodes, of corresponding reference beams that allow beam quality measurements by the target device.

The proposed technology also provides a carrier comprising the computer program, wherein the carrier is one of an electronic signal, an optical signal, an electromagnetic signal, a magnetic signal, an electric signal, a radio signal, a microwave signal, or a computer-readable storage medium.

By way of example, the software or computer program 325; 335 may be realized as a computer program product, which is normally carried or stored on a computer-readable medium 320; 330, in particular a non-volatile medium. The computer-readable medium may include one or more removable or non-removable memory devices including, but not limited to a Read-Only Memory (ROM), a Random Access Memory (RAM), a Compact Disc (CD), a Digital Versatile Disc (DVD), a Blu-ray disc, a Universal Serial Bus (USB) memory, a Hard Disk Drive (HDD) storage device, a flash memory, a magnetic tape, or any other conventional memory device. The computer program may thus be loaded into the operating memory of a computer or equivalent processing device for execution by the processing circuitry thereof.

The flow diagram or diagrams presented herein may be regarded as a computer flow diagram or diagrams, when performed by one or more processors. A corresponding apparatus may be defined as a group of function modules, where each step performed by the processor corresponds to a function module. In this case, the function modules are implemented as a computer program running on the processor.

The computer program residing in memory may thus be organized as appropriate function modules configured to perform, when executed by the processor, at least part of the steps and/or tasks described herein.

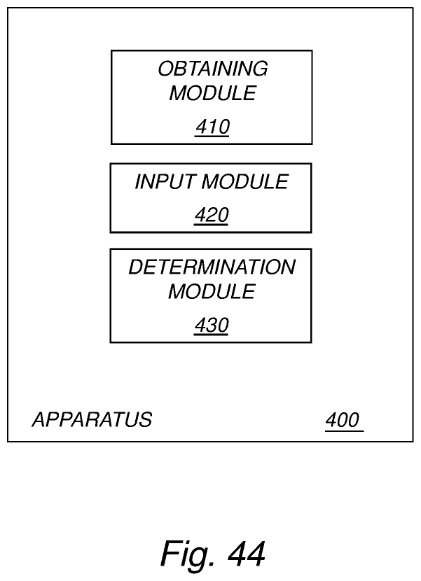

FIG. 44 is a schematic diagram illustrating an example of an apparatus for positioning of a target device in a wireless communication system.

In this example, the apparatus 400 comprises:
an obtaining module 410 for obtaining beam quality information relating to reference beams transmitted from at least two network nodes according to specific beam patterns;
an input module 420 for receiving beam pattern information representative of the specific beam patterns; and
a determination module 430 for determining a position of the target device based on the beam quality information and the beam pattern information.

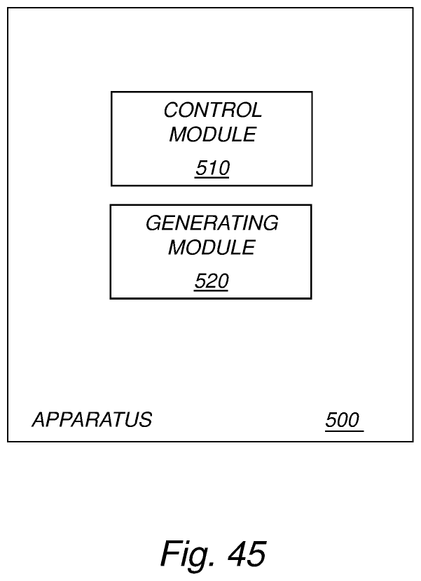

FIG. 45 is a schematic diagram illustrating an example of an apparatus for assisting in the positioning of a target device in a wireless communication system.

In this example, the apparatus 500 comprises:
a control module 510 for controlling the target device to perform beam quality measurements on reference beams transmitted from at least two network nodes according to specific beam patterns;
a generating module 520 for generating a report on beam quality information, comprising information representative of the beam quality measurements and information representative of said at least two network nodes, for transmission to a location server in the wireless communication system to enable positioning of the target device based on the beam quality information and beam pattern information representative of the specific beam patterns.

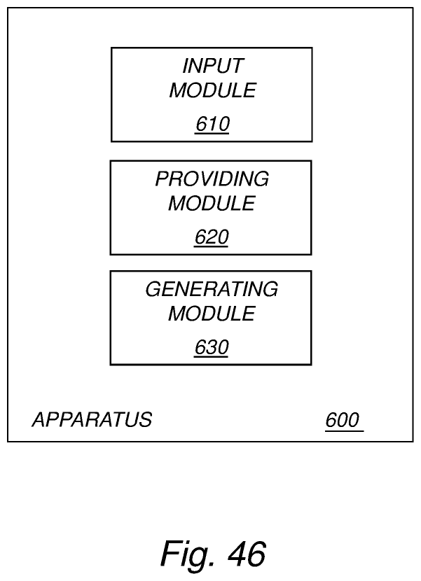

FIG. 46 is a schematic diagram illustrating an example of an apparatus for assisting in the positioning of a target device in a wireless communication system.

In this example, the apparatus 600 comprises:
an input module 610 for receiving a request for beam pattern information;
a providing module 620 for providing, in response to the request, beam pattern information representative of at least one specific beam pattern used for transmission of at least one reference beam that allows beam quality measurements by the target device; and
a generating nodule 630 for generating a report on the beam pattern information for transmission to the target device or a location server in the wireless communication system for enabling positioning of the target device based on the beam pattern.

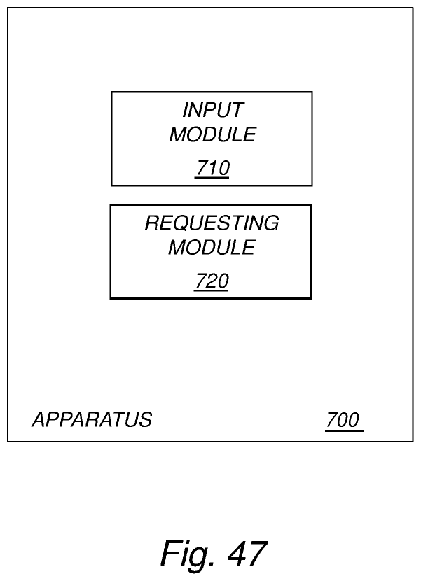

FIG. 47 is a schematic diagram illustrating an example of an apparatus for assisting in the positioning of a target device in a wireless communication system.

In this example, the apparatus 700 comprises:
an input module 710 for receiving a positioning request from the target device; and
a requesting module 720 for requesting at least two network nodes to send, to the target device or to a location server, beam pattern information representative of specific beam patterns used for transmission, from said at least two network nodes, of corresponding reference beams that allow beam quality measurements by the target device.

Alternatively it is possible to realize the module(s) in FIGS. 44-47 predominantly by hardware modules, or alternatively by hardware, with suitable interconnections between relevant modules. Particular examples include one or more suitably configured digital signal processors and other known electronic circuits, e.g. discrete logic gates interconnected to perform a specialized function, and/or Application Specific Integrated Circuits (ASICs) as previously mentioned. Other examples of usable hardware include input/output (I/O) circuitry and/or circuitry for receiving and/or sending signals. The extent of software versus hardware is purely implementation selection.

It is becoming increasingly popular to provide computing services (hardware and/or software) in network devices such as network nodes and/or servers where the resources are delivered as a service to remote locations over a network. By way of example, this means that functionality, as described herein, can be distributed or re-located to one or more separate physical nodes or servers. The functionality may be re-located or distributed to one or more jointly acting physical and/or virtual machines that can be positioned in separate physical node(s), i.e. in the so-called cloud. This is sometimes also referred to as cloud computing, which is a model for enabling ubiquitous on-demand network access to a pool of configurable computing resources such as networks, servers, storage, applications and general or customized services.

There are different forms of virtualization that can be useful in this context, including one or more of:
Consolidation of network functionality into virtualized software running on customized or generic hardware. This is sometimes referred to as network function virtualization.
Co-location of one or more application stacks, including operating system, running on separate hardware onto a single hardware platform. This is sometimes referred to as system virtualization, or platform virtualization.
Co-location of hardware and/or software resources with the objective of using some advanced domain level scheduling and coordination technique to gain increased system resource utilization. This is sometimes referred to as resource virtualization, or centralized and coordinated resource pooling.

Although it may often desirable to centralize functionality in so-called generic data centers, in other scenarios it may in fact be beneficial to distribute functionality over different parts of the network.

A Network Device (ND) may generally be seen as an electronic device being communicatively connected to other electronic devices in the network.

By way of example, the network device may be implemented in hardware, software or a combination thereof. For example, the network device may be a special-purpose network device or a general purpose network device, or a hybrid thereof.

A special-purpose network device may use custom processing circuits and a proprietary operating system (OS), for execution of software to provide one or more of the features or functions disclosed herein.

A general purpose network device may use common off-the-shelf (COTS) processors and a standard OS, for execution of software configured to provide one or more of the features or functions disclosed herein.

By way of example, a special-purpose network device may include hardware comprising processing or computing resource(s), which typically include a set of one or more processors, and physical network interfaces (NIs), which sometimes are called physical ports, as well as non-transitory machine readable storage media having stored thereon software. A physical NI may be seen as hardware in a network device through which a network connection is made, e.g. wirelessly through a wireless network interface controller (WNIC) or through plugging in a cable to a physical port connected to a network interface controller (NIC). During operation, the software may be executed by the hardware to instantiate a set of one or more software instance(s). Each of the software instance(s), and that part of the hardware that executes that software instance, may form a separate virtual network element.

By way of another example, a general purpose network device may for example include hardware comprising a set of one or more processor(s), often COTS processors, and network interface controller(s) (NICs), as well as non-transitory machine readable storage media having stored thereon software. During operation, the processor(s) executes the software to instantiate one or more sets of one or more applications. While one embodiment does not implement virtualization, alternative embodiments may use different forms of virtualization—for example represented by a virtualization layer and software containers. For example, one such alternative embodiment implements operating system-level virtualization, in which case the virtualization layer represents the kernel of an operating system (or a shim executing on a base operating system) that allows for the creation of multiple software containers that may each be used to execute one of a sets of applications. In an example embodiment, each of the software containers (also called virtualization engines, virtual private servers, or jails) is a user space instance (typically a virtual memory space). These user space instances may be separate from each other and separate from the kernel space in which the operating system is executed; the set of applications running in a given user space, unless explicitly allowed, cannot access the memory of the other processes. Another such alternative embodiment implements full virtualization, in which case: 1) the virtualization layer represents a hypervisor (sometimes referred to as a Virtual Machine Monitor (VMM)) or the hypervisor is executed on top of a host operating system; and 2) the software containers each represent a tightly isolated form of software container called a virtual machine that is executed by the hypervisor and may include a guest operating system.

A hypervisor is the software/hardware that is responsible for creating and managing the various virtualized instances and in some cases the actual physical hardware. The hypervisor manages the underlying resources and presents them as virtualized instances. What the hypervisor virtualizes to appear as a single processor may actually comprise multiple separate processors. From the perspective of the operating system, the virtualized instances appear to be actual hardware components.

A virtual machine is a software implementation of a physical machine that runs programs as if they were executing on a physical, non-virtualized machine; and applications generally do not know they are running on a virtual machine as opposed to running on a “bare metal” host electronic device, though some systems provide para-virtualization which allows an operating system or application to be aware of the presence of virtualization for optimization purposes.

The instantiation of the one or more sets of one or more applications as well as the virtualization layer and software containers if implemented, are collectively referred to as software instance(s). Each set of applications, corresponding software container if implemented, and that part of the hardware that executes them (be it hardware dedicated to that execution and/or time slices of hardware temporally shared by software containers), forms a separate virtual network element(s).

The virtual network element(s) may perform similar functionality compared to Virtual Network Element(s) (VNEs). This virtualization of the hardware is sometimes referred to as Network Function Virtualization (NFV)). Thus, NFV may be used to consolidate many network equipment types onto industry standard high volume server hardware, physical switches, and physical storage, which could be located in data centers, NDs, and Customer Premise Equipment (CPE). However, different embodiments may implement one or more of the software container(s) differently. For example, while embodiments are illustrated with each software container corresponding to a VNE, alternative embodiments may implement this correspondence or mapping between software container-VNE at a finer granularity level; it should be understood that the techniques described herein with reference to a correspondence of software containers to VNEs also apply to embodiments where such a finer level of granularity is used.

According to yet another embodiment, there is provided a hybrid network device, which includes both custom processing circuitry/proprietary OS and COTS processors/standard OS in a network device, e.g. in a card or circuit board within a network device ND. In certain embodiments of such a hybrid network device, a platform Virtual Machine (VM), such as a VM that implements functionality of a special-purpose network device, could provide for para-virtualization to the hardware present in the hybrid network device.

The embodiments described above are merely given as examples, and it should be understood that the proposed technology is not limited thereto. It will be understood by those skilled in the art that various modifications, combinations and changes may be made to the embodiments without departing from the present scope as defined by the appended claims. In particular, different part solutions in the different embodiments can be combined in other configurations, where technically possible.

1-14. (canceled)

15. A method for assisting in the positioning of a target device in a wireless communication system, wherein the method comprises:
the target device performing beam quality measurements on reference beams transmitted from at least two network nodes according to specific beam patterns;
the target device reporting beam quality information comprising information representative of the beam quality measurements and information representative of said at least two network nodes to a location server in the wireless communication system to enable positioning of the target device based on the beam quality information and beam pattern information representative of the specific beam patterns.

16. The method of claim 15, wherein the beam pattern information for each reference beam corresponds to the specific beam pattern used at the time of measurement of the reference beam.

17. The method of claim 15, wherein the step of reporting comprises generating a measurement report for positioning of the target device including the beam quality information and sending the measurement report to the location server.

18. The method of claim 15, wherein the beam quality information is associated with time stamp information representative of the time of measurement of each reference beam.

19. The method of claim 15, wherein the method further comprises receiving a request from the location server for performing the beam quality measurements and reporting the beam quality information.

20. A method for assisting in the positioning of a target device in a wireless communication system, wherein the method comprises:
a network node receiving a request for beam pattern information;
the network node providing, in response to the request, beam pattern information representative of at least one specific beam pattern used for transmission of at least one reference beam that allows beam quality measurements by the target device; and
the network node reporting the beam pattern information to the target device or a location server in the wireless communication system for enabling positioning of the target device based on the beam pattern information and corresponding beam quality measurements.

21. The method of claim 20, wherein the request for beam pattern information comprises time stamp information, and the step of providing beam pattern information comprises providing beam pattern information representative of at least one specific beam pattern used for transmission of at least one reference beam at a time indicated by the time stamp information.

22. The method of claim 20, wherein the method further comprises transmitting the reference beams according to the specific beam pattern.

23-31. (canceled)

32. A device configured to assist in the positioning of a target device in a wireless communication system, wherein the device is configured to perform beam quality measurements on reference beams transmitted from at least two network nodes according to specific beam patterns, and
wherein the device is configured to report beam quality information comprising information representative of the beam quality measurements and information representative of said at least two network nodes to a location server in the wireless communication system to enable positioning of the target device based on the beam quality information and beam pattern information representative of the specific beam patterns.

33. (canceled)

34. The device of claim 32, wherein the device comprises a processor and memory, the memory comprising instructions, which when executed by the processor, cause the processor to determine the position of the target device or assist in the positioning of the target device.

35. A network node configured to assist in the positioning of a target device in a wireless communication system, wherein the network node is configured to receive a request for beam pattern information,
wherein the network node is configured to provide, in response to the request, beam pattern information representative of at least one specific beam pattern used for transmission of at least one reference beam that allows beam quality measurements by the target device, and
wherein the network node is configured to report the beam pattern information to the target device or a location server in the wireless communication system for enabling positioning of the target device based on the beam pattern information and corresponding beam quality measurements.

36. The network node of claim 35, wherein the request for beam pattern information comprises time stamp information, and the network node is configured to provide beam pattern information by providing beam pattern information representative of at least one specific beam pattern used for transmission of at least one reference beam at a time indicated by the time stamp information.

37. The network node of claim 36, wherein the network node is configured to transmit the reference beams according to the specific beam pattern.

38-49. (canceled)
